(19) United States
(12) Patent Application Publication
(10) Pub. No.: US 2013/0337249 A1
(43) Pub. Date: Dec. 19, 2013

(54) Insulating Material Comprising Nonwoven Webs

(71) Applicants: Gyorgyi Fenyvesi, Wilmington, DE (US); Mark Andrew Harmer, Landenberg, PA (US); Byoung Sam Kang, Midlothian, VA (US); Lakshmi Krishnamurthy, Wilmington, DE (US); Serge Rebouillat, Echenevex (FR); Peter A. Brown, Wilmington, DE (US); Weiming Qiu, Wilmington, DE (US)

(72) Inventors: Gyorgyi Fenyvesi, Wilmington, DE (US); Mark Andrew Harmer, Landenberg, PA (US); Byoung Sam Kang, Midlothian, VA (US); Lakshmi Krishnamurthy, Wilmington, DE (US); Serge Rebouillat, Echenevex (FR); Peter A. Brown, Wilmington, DE (US); Weiming Qiu, Wilmington, DE (US)

(73) Assignee: E I DU PONT DE NEMOURS AND COMPANY, Wilmington, DE (US)

(21) Appl. No.: 13/593,968

(22) Filed: Aug. 24, 2012

Related U.S. Application Data
(60) Provisional application No. 61/527,886, filed on Aug. 26, 2011.
(60) Provisional application No. 61/527,903, filed on Aug. 26, 2011.
(60) Provisional application No. 61/527,925, filed on Aug. 26, 2011.
(60) Provisional application No. 61/538,318, filed on Sep. 23, 2011.
(60) Provisional application No. 61/538,303, filed on Sep. 23, 2011.
(60) Provisional application No. 61/538,298, filed on Sep. 23, 2011.
(60) Provisional application No. 61/548,869, filed on Oct. 19, 2011.
(60) Provisional application No. 61/548,870, filed on Oct. 19, 2011.

(51) Int. Cl. H01B 3/50

(52) U.S. Cl. CPC H01B 3/50
USPC 428/219; 442/364; 442/117

(57) ABSTRACT

Insulating materials are provided, the insulating materials comprising a nonwoven web comprising a plurality of continuous spunbonded polyester bicomponent fibers. Each of the plurality of bicomponent fibers comprises a) from about 20% by weight to about 80% by weight of poly(ethylene terephthalate) in a core, and b) from about 80% by weight to about 20% by weight of poly(trimethylene terephathalate) in a sheath surrounding the core, wherein the amounts in percent by weight are based on the total weight of each of the plurality of bicomponent fibers. Also provided are electrical apparatuses comprising the insulating materials and a dielectric fluid, as well as a dielectric material comprising the nonwoven web impregnated with at least 10 weight percent of a dielectric fluid.

This application claims benefit of priority from U.S. Provisional Application No. 61/527,886 (attorney docket number CL5235 USPRV), filed Aug. 26, 2011; U.S. Provisional Application No. 61/527,903 (attorney docket number CL5490 USPRV), filed Aug. 26, 2011; U.S. Provisional Application No. 61/527,925 (attorney docket number CL5491 USPRV), filed Aug. 26, 2011;

U.S. Provisional Application No. 61/538,318 (attorney docket CL5307 USPRV), filed Sep. 23, 2011; U.S. Provisional Application No. 61/538,303 (attorney docket CL5431 USPRV), filed Sep. 23, 2011; U.S. Provisional Application No. 61/538,298 (attorney docket CL5432 USPRV), filed Sep. 23, 2011;

U.S. Provisional Application No. 61/548,869 (attorney docket number CL5235 USPRV1), filed Oct. 19, 2011; U.S. Provisional Application No. 61/548,870 (attorney docket number CL5490 USPRV1), filed Oct. 19, 2011; U.S. Provisional Application No. 61/548,885 (attorney docket number CL5491 USPRV1), filed Oct. 19, 2011;

U.S. Provisional Application No. 61/560,837 (attorney docket CL5235 USPRV2), filed Nov. 17, 2011; U.S. Provisional Application No. 61/560,852 (attorney docket CL5490 USPRV2), filed Nov. 17, 2011; and U.S. Provisional Application No. 61/560,853 (attorney docket CL5491 USPRV2), filed Nov. 17, 2011, all of which are incorporated by reference in their entirety.

### FIELD OF THE INVENTION

The present invention relates to nonwoven webs useful for electrical insulation. The nonwoven webs comprise a plurality of continuous spunbonded polyester bicomponent fibers.

### BACKGROUND

Electrical transformers typically have windings of conducting wire which must be separated by a dielectric (i.e. non-conducting) material. Usually the coils and dielectric material are immersed in a fluid dielectric heat transfer medium to insulate the conductor and to dissipate heat generated during operation. The heat-transfer medium must act as a dielectric as well. In a typical arrangement, cellulosic and/or aramid paper or board is used as the dielectric material. The cellulosic/aramid material is wrapped around the conducting wire, and used to separate the windings dielectrically, and may also be used as a structural support for the windings or other elements such as the cores. The fluid heat-transfer medium is typically an oil, which may be, for example mineral oil or a sufficiently robust vegetable oil.

During use of the transformer, the dielectric material and heat-transfer fluid are subjected to significant electromagnetic fields and significant variations of temperature, and power surges and breakdowns. Over time, the relatively extreme conditions can lead to failure of the dielectric material and/or deterioration of the heat-transfer fluid. The dielectric and heat-transfer fluid can furthermore be directly and indirectly degraded by oxygen migration and water formation or ingression in the transformer. Robust dielectric materials and heat-transfer fluids having extended useful lifetimes can provide economic advantages.

A variety of materials have been disclosed as useful in electrical transformer applications. For example, published patent application WO 2010/151548 discloses that the fabric for oil filled transformers can include paper, polyester, polyester film, aramid paper such as Nomex®, cellulose, Kraft paper, organic and inorganic papers, woven or non-woven materials, and laminates such as DMD.

A need remains for an alternative, lower cost insulating material having physical characteristics suitable for high temperature and for long term use in electrical transformers. Similarly, a need exists for an electrical apparatus comprising such insulating material. A need exists as well for a dielectric material comprising an alternative insulating material impregnated with a dielectric fluid.

### SUMMARY

In one embodiment, an insulating material is described, the insulating material comprising:

a nonwoven web comprising a plurality of continuous spunbonded polyester bicomponent fibers, wherein each of the plurality of bicomponent fibers comprises:

a) from about 20% by weight to about 80% by weight of poly(ethylene terephthalate) in a core; and

b) from about 80% by weight to about 20% by weight of poly(trimethylene terephathalate) in a sheath surrounding the core,

wherein the amounts in % by weight are based on the total weight of each of the plurality of bicomponent fibers.

In one embodiment, a dielectric material is described, the dielectric material comprising a nonwoven web impregnated with at least 10 wt % of a dielectric fluid, wherein the nonwoven web comprises a plurality of continuous spunbonded polyester bicomponent fibers, wherein each of the plurality of bicomponent fibers comprises:

a) from about 20% by weight to about 80% by weight of poly(ethylene terephthalate) in a core; and

b) from about 80% by weight to about 20% by weight of poly(trimethylene terephathalate) in a sheath surrounding the core,
wherein the amounts in % by weight are based on the total weight of each of the plurality of bicomponent fibers.

In one embodiment, an electrical apparatus is described, the electrical apparatus comprising:

a dielectric fluid and an insulating material;

wherein the insulating material comprises a nonwoven web comprising a plurality of continuous spunbonded polyester bicomponent fibers, and
wherein each of the plurality of bicomponent fibers comprises:

a) from about 20% by weight to about 80% by weight of poly(ethylene terephthalate) in a core; and

b) from about 80% by weight to about 20% by weight of poly(trimethylene terephathalate) in a sheath surrounding the core,

wherein the amounts in % by weight are based on the total weight of each of the plurality of bicomponent fibers.

### DETAILED DESCRIPTION OF THE INVENTION

Disclosed is an insulating material comprising a nonwoven web comprising a plurality of continuous spunbonded fibers, wherein each of the plurality of continuous spunbond fibers comprises poly(ethylene terephthalate) (PET) in a core and poly(trimethylene terephthalate) (PTT) in a sheath surrounding the core. Disclosed also is an electrical apparatus comprising a dielectric fluid and an insulating material, wherein the insulating material comprises a nonwoven web comprising a plurality of continuous spunbonded fibers, wherein each of the plurality of continuous spunbond fibers comprises poly(ethylene terephthalate) in a core and poly(trimethylene terephthalate) in a sheath surrounding the core. Further disclosed is a dielectric material comprising a nonwoven web impregnated with at least 10 wt % of a dielectric fluid, wherein the nonwoven web comprises a plurality of continuous spunbonded fibers, wherein each of the plurality of continuous spunbond fibers comprises poly(ethylene terephthalate) in a core and poly(trimethylene terephthalate) in a sheath surrounding the core.

The methods, compositions, and articles described herein are described with reference to the following terms.

As used herein, where the indefinite article “a” or “an” is used with respect to a statement or description of the presence of a step in a process of this invention, it is to be understood, unless the statement or description explicitly provides to the contrary, that the use of such indefinite article does not limit the presence of the step in the process to one in number.

As used herein, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but may include other elements not expressly listed or inherent to such composition, mixture, process, method, article, or apparatus.

As used herein, the term “wt %” means weight percent.

As used herein, the term “Kraft paper” means a paper made by a kraft pulping process wherein the paper consists of a web of pulp fibers (normally from wood or other vegetable fibers), is usually formed from an aqueous slurry on a wire or screen, and is held together by hydrogen bonding. Kraft paper may also contain a variety of additives and fillers. See, for example, Handbook of Pulping and Papermaking, Christopher J. Bierman, Academic Press, 1996.

As used herein, the term “thermally upgraded Kraft paper” means a kraft paper having epoxy resin applied to one or both sides of the paper to improve thermal performance of the paper.

As used herein, the term “nonwoven web” is used interchangeably with “nonwoven sheet”, “nonwoven layer” and “nonwoven fabric”. As used herein, the term “nonwoven” means a manufactured sheet, web or batt of randomly orientated fibers, filaments, or threads positioned to form a planar material without an identifiable pattern. Examples of nonwoven webs include meltblown webs, spunbond webs, carded webs, air-laid webs, wet-laid webs, and spunlaced webs and composite webs comprising more than one nonwoven layer. Nonwoven webs for the processes and articles disclosed herein are desirably prepared using a “direct laydown” process. “Direct laydown” means spinning and collecting individual fibers or plexifilaments directly into a web or sheet without winding filaments on a package or collecting a tow.

The term “spunbond fibers” as used herein means fibers that are formed by extruding molten thermoplastic polymer material as fibers from a plurality of fine, usually circular, capillaries of a spinneret with the diameter of the extruded fibers then being rapidly reduced by drawing and then quenching the fibers. Other fiber cross-sectional shapes such as oval, multi-lobal, etc. can also be used. Spunbond fibers are generally continuous and usually have an average diameter of greater than about 5 micrometers. Spunbond nonwoven webs are formed by laying fibers randomly on a collecting surface such as a foraminous screen or belt and spunbonding the fibers by methods known in the art such as by hot-roll calendering or by passing the web through a saturated-steam chamber at an elevated pressure. For example, the nonwoven web can be thermally point bonded at a plurality of thermal bond points located across the nonwoven web.

As used herein, the term “bicomponent fiber” refers to a fiber comprising a pair of polymer compositions intimately adhered to each other along the length of the fiber, so that the fiber cross-section is, for example, a side-by-side, sheath-core or other suitable cross-section. The bicomponent sheath/core polymeric fibers can be round, trilobal, pentalobal, octalobal, like a Christmas tree, dumbbell-shaped, island-in-the-sea or otherwise star shaped in cross section. The fibers may also be in a side by side arrangement.

As used herein, the term “continuous fiber” refers to a fiber of indefinite or extreme length. In practice, there could be one or more breaks in the “continuous fiber” due to manufacturing process, but a “continuous fiber” is distinguishable from a staple fiber which is cut to a predetermined length.

Nonwoven webs comprising a plurality of continuous spunbonded bicomponent fibers in a sheath-core configuration are disclosed in commonly-owned U.S. patent application Ser. No. 12/971,415, filed on Dec. 17, 2010, which is herein incorporated by reference in its entirety. The weight ratio between the sheath component and the core component of the spunbonded bicomponent fibers is preferably 25:75. The bicomponent fibers have an average fiber diameter in the range of 2 microns to 20 microns. In an embodiment, each bicomponent fiber comprises 75% by weight of PET in the core and 25% by weight of PTT in the sheath surrounding the core. In another embodiment, each bicomponent fiber comprises 50% by weight of PET in the core and 50% by weight of PTT in the sheath surrounding the core.

In another embodiment, each bicomponent fiber comprises from about 20% by weight to about 80% by weight of PET in the core and from about 80% by weight to about 20% by weight of PTT in the sheath surrounding the core. In another embodiment, each bicomponent fiber comprises from about 25% by weight to about 50% by weight of poly(ethylene terephthalate) in the core and from about 75% by weight to about 50% by weight of poly(trimethylene terephthalate) in the sheath surrounding the core.

The PTT used in the sheath component of the spunbond fibers of the disclosed nonwoven web has an intrinsic viscosity in the range of 0.9 dl/g to 1.3 dl/g or 0.95 dl/g to 1.05 dl/g.

In an embodiment, “poly(trimethylene terephthalate)” (PTT) is a homopolymer or a copolymer comprising at least 70 mole percent trimethylene terephthalate repeating units. The preferred poly(trimethylene terephthalate)s contain at least 85 mole percent, more preferably at least 90 mole percent, even more preferably at least 95 or at least 98 mole percent, and most preferably about 100 mole percent, trimethylene terephthalate repeating units.

Examples of copolymers include copolyesters made using 3 or more reactants, each having two ester forming groups. For example, a copoly(trimethylene terephthalate) can be made using a comonomer selected from the group consisting of linear, cyclic, and branched aliphatic dicarboxylic acids having 4-12 carbon atoms (for example butanedioic acid, pentanedioic acid, hexanedioic acid, dodecanedioic acid, and 1,4-cyclo-hexanedicarboxylic acid); aromatic dicarboxylic acids other than terephthalic acid and having 8-12 carbon atoms (for example isophthalic acid and 2,6-naphthalenedicarboxylic acid); linear, cyclic, and branched aliphatic diols having 2-8 carbon atoms (other than 1,3-propanediol, for example, ethanediol, 1,2-propanediol, 1,4-butanediol, 3-methyl-1,5-pentanediol, 2,2-dimethyl-1,3-propanediol, 2-methyl-1,3-propanediol, and 1,4-cyclohexanediol). The comonomer typically is present in the copolyester at a level in the range of about 0.5 to about 15 mole percent, and can be present in amounts up to 30 mole percent.

In one embodiment, PTT is made by polycondensation of 1,3-propanediol derived from a renewable source and terephthalic acid or acid equivalent. In one embodiment, the PTT contains at least 20% renewably sourced ingredient by weight and in some cases at least 30%. An exemplary PTT suitable for the disclosed nonwoven web is available from DuPont Company (Wilmington, Del.) under the trademark Sorona®. In an embodiment, the disclosed nonwoven webs have renewably sourced content of at least 5% by total weight of the web.

The renewably sourced 1,3-propanediol contains carbon from the atmospheric carbon dioxide incorporated by plants, which compose the feedstock for the production of the 1,3-propanediol. In other words, the renewably sourced 1,3-propanediol contains only renewable carbon, and not fossil fuel-based or petroleum-based carbon.

A particularly preferred renewable source of 1,3-propanediol is via a fermentation process using a renewable biological source such as corn feed stock. For example, bacterial strains able to convert glycerol into 1,3-propanediol are found in the species Klebsiella, Citrobacter, Clostridium, and Lactobacillus. The technique is disclosed in several publications, including U.S. Pat. Nos. 5,633,362, 5,686,276 and 5,821,092. U.S. Pat. No. 5,821,092 discloses, inter alia, a process for the biological production of 1,3-propanediol from glycerol using recombinant organisms. The process incorporates E. coli bacteria, transformed with a heterologous pdu diol dehydratase gene, having specificity for 1,2-propanediol. The transformed E. coli is grown in the presence of glycerol as a carbon source and 1,3-propanediol is isolated from the growth media. Since both bacteria and yeasts can convert glucose (e.g., corn sugar) or other carbohydrates to glycerol, the processes disclosed in these publications provide a renewable source of 1,3 propanediol monomer.

Therefore, PTT derived from the renewably sourced 1,3-propanediol has less impact on the environment as the 1,3 propanediol used in the compositions does not deplete diminishing fossil fuels and, upon degradation, releases carbon back to the atmosphere for use by plants once again. Thus, the compositions of the present invention can be characterized as more natural and having less environmental impact than similar compositions comprising petroleum based 1,3 propanediol.

Poly(ethylene terephthalate) (PET) can include a variety of comonomers, including diethylene glycol, cyclohexanedimethanol, poly(ethylene glycol), glutaric acid, azelaic acid, sebacic acid, isophthalic acid, and the like. In addition to these comonomers, branching agents like trimesic acid, pyromellitic acid, trimethylolpropane and trimethyloloethane, and pentaerythritol may be used. The poly(ethylene terephthalate) can be obtained by known polymerization techniques from either terephthalic acid or its lower alkyl esters (e.g. dimethyl terephthalate) and ethylene glycol or blends or mixtures of these. The PET used in the core component of the spunbond fibers of the disclosed nonwoven web has an intrinsic viscosity in the range of 0.58 dl/g to 0.75 dl/g or 0.62 dl/g to 0.69 dl/g.

The sheath and/or core component of the sheath-core spunbond fibers can include other conventional additives such as dyes, pigments, antioxidants, ultraviolet stabilizers, spin finishes, and the like. In an embodiment, the sheath comprises 0.1% to 0.33% by weight of titanium dioxide dispersed in the PTT, the titanium dioxide having an average particle size of about 300 nm.

The nonwoven web disclosed hereinabove can be prepared using spunbonding methods known in the art, for example as described in Rudisill, et al. U.S. Patent application Ser. No. 60/146,896 filed on Aug. 2, 1999, which is hereby incorporated by reference (published as PCT Application WO 01/09425). The spunbonding process can be performed using either pre-coalescent dies, wherein the distinct polymeric components are contacted prior to extrusion from the extrusion orifice, or post-coalescent dies, in which the distinct polymeric components are extruded through separate extrusion orifices and are contacted after exiting the capillaries to form the bicomponent fibers.

The disclosed nonwoven web can be made using any suitable bicomponent spinning system, for example Model # NF5, manufactured by Nordson Fiber Systems Inc. (Duluth, Ga.) and Hills Inc. (W. Melbourne, Fla.). First, the two polymers PET and PTT are dried at a temperature in the range of 90° C. to 120° C. to a moisture content of less than 50 ppm. After drying, the two polymers are separately extruded at a temperature above their melting point and below the lowest decomposition temperature. PTT can be extruded at 245° C. to 265° C. and PET at 280° C. to 295° C. After extrusion, the two polymers are metered to a spin-pack assembly, where the two melt streams are separately filtered and then combined through a stack of distribution plates to provide multiple rows of sheath-core fiber cross-sections. The spin-pack assembly is kept at 285° C. to 295° C. The PTT and PET polymers can be spun through the each capillary at a polymer throughput rate of 0.5 g/hole/min to 3 g/hole/min. An attenuating force using rectangular slot jet can be applied to the bundle of fibers. The bicomponent fibers exiting the jet are collected on a forming belt to form a nonwoven web of bicomponent fibers. Vacuum can be applied underneath the belt to help pin the nonwoven web to the belt. The speed of the belt can be varied to obtain nonwoven webs of various basis weights.

The nonwoven web can be thermally bonded using methods known in the art. In one embodiment, the nonwoven web is thermally bonded with a discontinuous pattern of points, lines, or other pattern of intermittent bonds using methods known in the art. Intermittent thermal bonds can be formed by applying heat and pressure at discrete spots on the surface of the spunbond web, for example by passing the layered structure through a nip formed by a patterned calender roll and a smooth roll, or between two patterned rolls. One or both of the rolls are heated to thermally bond the web. When web breathability is important, such as in garment end uses, the webs are preferably bonded intermittently to provide a more breathable web.

In one method, the nonwoven web is thermally bonded in a nip formed between two smooth metal rolls at bonding temperature in the range of 110° C. to 130° C. and a bonding nip pressure in the range of 500 N/cm to 1500 N/cm. The optimum bonding temperature and pressure are functions of the line speed during bonding, with faster line speeds generally requiring higher bonding temperatures. The thermally bonded sheet was then wound onto a roll.

During thermal pattern bonding, the PTT in the sheath component of the spunbond fibers is partially melted in the discrete areas corresponding to raised protuberances on the patterned roll to form fusion bonds that bond the spunbond fibers together to form a cohesively bonded spunbond sheet. Depending on the bonding conditions and polymers used in the sheath component, the polyethylene in the sheath component may also be partially melted during thermal pattern bonding. The PET core component is not melted during thermal bonding and contributes to the strength of the web. The bonding roll pattern may be any of those known in the art, and preferably is a pattern of discrete point or line bonds. The nonwoven web can also be thermally bonded using ultrasonic energy, for example by passing the web between a horn and a rotating anvil roll, for example an anvil roll having a pattern of protrusions on the surface thereof.

Alternately, the nonwoven web can be bonded using through-air bonding methods known in the art, wherein heated gas such as air is passed through the web at a temperature sufficient to bond the fibers together where they contact each other at their cross-over points while the web is supported on a porous surface.

The spunbonded nonwoven webs comprising PTT-PET as sheath-core fibers have surprisingly higher strength (tensile strength, grab tear strength, and Mullen burst) than a comparable nonwoven web of PET-PTT as sheath-core fibers or 100% PTT fibers or 100% PET fibers. The nonwoven webs have a basis weight in the range of 25 gsm to 500 gsm or 40 gsm to 200 gsm or 50 gsm to 150 gsm. As used herein, the term “machine direction” (MD) refers to the direction in which a nonwoven web is produced (e.g. the direction of travel of the supporting surface upon which the fibers are laid down during formation of the nonwoven web). The term “cross direction” (XD) refers to the direction generally perpendicular to the machine direction in the plane of the web.

The nonwoven webs can have a tensile strength per unit basis weight in the range of 0.7 N/gsm to 5 N/gsm or 0.75 N/gsm to 2 N/gsm, measured in both the machine direction and the cross-direction of the web (according to ASTM D1117-01 and D5035-95). The nonwoven webs can have a grab tear strength per unit basis weight in the range of 1.5 N/gsm to 10 N/gsm or 1.5 N/gsm to 5 N/gsm, measured in both the machine direction and the cross-direction of the web (according to ASTM D1117-01. The nonwoven webs can have a Mullen burst per unit basis weight in the range of 3.5 KPa/gsm to 10 KPa/gsm or 3.5 KPa/gsm to 5 KPa/gsm, measured in both the machine direction and the cross-direction of the web. The nonwoven webs can have a trapezoidal tear strength per unit basis weight in the range of 0.4 N/gsm to 5 N/gsm or 0.4 N/gsm to 0.75 N/gsm, measured in both the machine direction and the cross-direction of the web (according to ASTM 5733). The nonwoven webs can be pressed or calendered.

Insulating material comprising a nonwoven web as described herein can be used with dielectric fluids comprising a triglyceride oil, such as vegetable oils, vegetable oil based fluids, and algal oils. Dielectric fluids such as mineral oil, synthetic esters, silicon fluids, and poly alpha olefins may also be used. Typically, the dielectric fluid has a water content of about 500 ppm or less. Examples of vegetable oils include but are not limited to sunflower oil, canola oil, rapeseed oil, corn oil, olive oil, coconut oil, palm oil, high oleic soybean oil, commodity soybean oil, castor oil, and mixtures thereof. Examples of vegetable oil based fluids that can be used are Envirotemp® FR3™ fluid (Cooper Industries, Inc.) and BIOTEMP® Biodegradable Dielectric Insulating Fluid (ABB). The term “algal oil” refers to the lipid components, including triacylglycerols, produced by miroalgal cells such as Chlorella, Parachlorella, Dunaliella, and others, for example as disclosed in published patent application US 2010/0303957. An example of a high fire point hydrocarbon oil that can be used is R-Temp® hydrocarbon oil (Cooper Industries, Inc.). Examples of synthetic esters include polyol esters which contain fatty acid moieties of less than about 10 carbon atoms in chain length. Commercially available synthetic esters that can be used include those sold under the trade names Midel® 7131 (The Micanite and Insulators Co., Manchester UK), REOLEC® 138 fluid (FMC, Manchester, UK), and ENVIROTEMP 200 fire-resistant fluid (Cooper Power Fluid Systems).

In one embodiment, the dielectric fluid comprises a triglyceride oil. In one embodiment, the triglyceride oil comprises a vegetable oil, a vegetable oil based fluid, an algal oil, or mixtures thereof. In one embodiment, the vegetable oil comprises high oleic soybean oil.

Insulating material comprising a nonwoven web as described herein can also be used with dielectric fluids comprising a mixture of polyol esters derived from a reaction of a polyol comprising pentaerythritol, trimetholpropane, neopentyl glycol, or combinations thereof and a mixture of fatty acid esters derived from a high oleic soybean oil comprising fatty acid moieties, wherein the high oleic soybean oil has i) a C18:1 content of greater than 65% of the fatty acid moieties in the oil; and ii) a combined C18:2 and C18:3 content of less than 20% of the fatty acid moieties in the oil. Such dielectric fluids possess a wide variety of desirable properties, including good oxidative stability. Oxidative stability is related to the degree of unsaturation in the dielectric fluid and can be measured, for example by using a standard method for determining an oil stability index. The high oleic acid content of the soybean oil used to prepare the mixture of polyol esters helps to provide good oxidative stability to the dielectric fluids. In addition, such dielectric fluids are expected to be biodegradable as they are derived from a vegetable oil which is readily biodegradable. A dielectric fluid comprising a mixture of TMP esters derived from the fatty acids of crude HOS oil has been found to meet the criteria for “Ready Biodegradation” under the conditions of the 28-day CO₂ Evolution test according to OECD Guideline 301B. Published Canadian Patent Application CA 2594765 discloses a biodegradability (28d BOD/COD) of 72% for the trioleate ester of trimethylolpropane. In preferred embodiments, the dielectric fluid comprises at least about 30 wt %, or at least about 50 wt %, or at least about 70 weight percent, or at least about 80 wt %, or at least about 90 wt % to about 100 wt %, of the mixture of polyol esters comprising the fatty acid moieties of the HOS oil.

In one embodiment, the dielectric fluid comprises a triglyceride oil, a mixture comprising polyol esters, or combinations thereof; wherein the triglyceride oil comprises a vegetable oil, a vegetable oil based fluid, an algal oil, or mixtures thereof; and the mixture comprising polyol esters is derived from reaction of: a) a polyol comprising pentaerythritol, trimethylolpropane, neopentyl glycol, or combinations thereof; and b) a mixture of fatty acid esters derived from a high oleic soybean oil comprising fatty acid moieties; wherein the high oleic soybean oil has i) a C18:1 content of greater than 65% of the fatty acid moieties in the oil; and ii) a combined C18:2 and C18:3 content of less than 20% of the fatty acid moieties in the oil.

Vegetable oils usually have a high percentage of triglyceride esters of saturated and unsaturated organic acids. Oleic acid is a monounsaturated acid found as triglyceride ester in many natural oils including sunflower, olive oil, safflower, canola oil, and soybean oil. High oleic soybean (HOS) oil may be derived from high oleic soybean seeds which have been genetically modified to yield high oleic content, as disclosed in World Patent Publication WO 94/11516, which is hereby incorporated in its entirety by reference. A high oleic soybean seed is a soybean seed wherein oleic acid accounts for greater than 65 percent of the fatty acid moieties in the oil and, preferably, greater than 75 percent of the fatty acid moieties in the oil. High oleic soybean oil may be derived from high oleic soybean seeds as disclosed in U.S. Pat. No. 5,981,781, which is hereby incorporated in its entirety by reference. High oleic soybean oil may be purified by such process steps as refining, bleaching, and deodorizing, as described in U.S. Pat. No. 5,981,781, to obtain refined, bleached, and deodorized high oleic soybean oil (RBD HOS oil). HOS Oil and/or RBD HOS oil may be used in the processes disclosed herein to prepare dielectric fluids comprising a mixture of polyol esters. In one embodiment, HOS oil may comprise refined, bleached, and deodorized high oleic soybean oil.

A triglyceride composition is a glycerol backbone linked to three fatty acid molecules. Pure vegetable oils are triglycerides of certain fatty acids with a carbon chain generally ranging from 16 to 22 carbon atoms, although small amounts of shorter and/or longer carbon chains can also be present. If the carbon chain has no double bonds, it is a saturated oil, and is designated Cn:0 where n is the number of carbon atoms. Carbon chains with one double bond are monounsaturated and are designated Cn:1; those with two double bonds are designated Cn:2, and those with three double bonds are designated Cn:3. As examples, palmitic acid is a C16:0 acid, stearic acid is a C18:0 acid, oleic acid is a C18:1 acid, linoleic acid is a C18:2 acid, and linolenic acid is a C18:3 acid. The acids are in the combined state as triglycerides, and when the oils are hydrolyzed they are separated into the acid and glycerol components.

High oleic soybean oil has a C18:1 content of greater than 65% of the fatty acid moieties in the oil and a combined C18:2 and C18:3 content of less than 20% of the fatty acid moieties in the oil. In one embodiment, the HOS oil has a C18:1 content of greater than about 70% of the fatty acid moieties, and a combined C18:2 and C18:3 content of less than 15% of the fatty acid. In one embodiment, the HOS oil further comprises a combined C16:0 and C18:0 content of less than 15% of the fatty acid moieties. In one embodiment, the HOS oil has a C18:1 content of greater than about 75% of the fatty acid moieties, and a combined C18:2 and C18:3 content of less than 10% of the fatty acid moieties. In one embodiment, the HOS oil has a C18:1 content of greater than about 80% of the fatty acid moieties, and a combined C18:2 and C18:3 content of less than 10% of the fatty acid.

A mixture of polyol esters can be obtained in two synthesis steps from HOS oil. In the first synthesis step, the HOS oil comprising fatty acid moieties is converted to glycerol and a mixture of fatty acid esters through base-catalyzed reaction with an alcohol. The mixture of fatty acid esters comprises the fatty acid moieties of the HOS oil. The first synthetic step is represented in Scheme I below, where the alcohol is shown as R⁴OH and R¹, R², and R³ represent the same or different C₁₅ to C₂₁ carbon chains of the fatty acid moieties in the triglyceride starting material and in the fatty acid ester products R¹CO₂R⁴, R²CO₂R⁴, and R³CO₂R⁴. Note that in Scheme I only one triglyceride of the HOS oil is shown as the starting material, although the HOS oil contains a mixture of triglycerides such that the C16:0, C18:0, C18:1, C18:2, and C18:3 contents of the fatty acid moieties described in the embodiments of the high oleic soybean oil herein above are met.

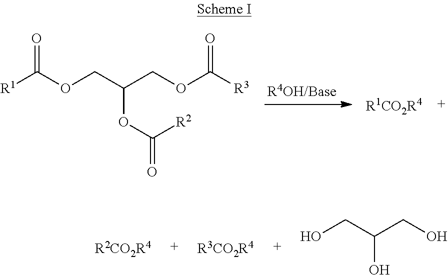

In the second synthesis step the mixture of fatty acid esters R¹CO₂R⁴, R²CO₂R⁴, and R³CO₂R⁴ is reacted with a polyol other than glycerol to produce a mixture of polyol esters, which comprises the fatty acid moieties of the HOS oil. The process for preparing a mixture of polyol esters can be performed as follows.

An HOS oil is reacted with an aliphatic monoalcohol having a chain length of from 1 to 5 carbons in the presence of a first base catalyst to produce a reaction mixture comprising glycerol and a mixture of the fatty acid esters corresponding to the fatty acid moieties of the HOS oil. In Scheme I the monoalcohol is shown as R⁴OH, where R⁴ represents an alkyl group containing from 1 to 5 carbons. This transesterification reaction can be driven to completion by (1) the use of excess monoalcohol (about 25 to 50 weight % based on HOS oil) and (2) separating and removing the glycerol that is formed during the transesterification of the fatty acid moieties of the HOS oil. Separation and removal of the glycerol also enables the ester mixture obtained in this step to be as free of any triglycerides of the HOS oil as possible. The glycerol may be separated, for example, by cooling the reaction mixture and allowing a bottom glycerol layer to form, due to glycerol having a higher density than the reaction mixture. Other conventional means of separation can be used such as liquid/liquid extraction, solvent extraction, salting out, or other separation methods that would not result in destruction of the esterified product. After separation the glycerol bottom layer can be physically removed by any conventional method known in the art.

The monoalcohol comprises methanol, ethanol, a propanol isomer, a butanol isomer, a pentanol isomer, or combinations thereof. In one embodiment, the monoalcohol comprises methanol. The first base catalyst can comprise sodium carbonate, potassium carbonate, lithium carbonate, sodium hydroxide, potassium hydroxide, lithium hydroxide, sodium methoxide, or combinations thereof. Other base catalysts known to one of ordinary skill can be used to obtain the same result, and any such catalyst can be useful in the practice of this invention. The amount of the first base catalyst used is typically from about 0.1 wt % to about 1.0 wt %, for example from about 0.1 wt % to about 0.5 wt %, based on the amount of HOS oil used. A larger amount of base can be used, but may not be necessary or economical. In one embodiment, the first base catalyst comprises sodium carbonate. In one embodiment, the first base catalyst comprises potassium carbonate. Transesterification of vegetable oil to the corresponding methyl esters is well-known and widely used to manufacture biodiesel, see for example [J. Braz. Chem. Soc., 1998, 9, 199-210].

Suitable reaction conditions for reacting HOS oil with an aliphatic monoalcohol include a reaction temperature from about 25° C. to about 150° C., for example from about 50° C. to about 100° C., and a reaction time from about 30 minutes to about 4 hours. In one embodiment, the reaction can be carried out under atmospheric pressure and refluxing conditions for about 3 or more hours.

In one embodiment, reacting the HOS oil with an aliphatic monoalcohol can be repeated more than once in a multi-stage process. The first stage is performed as described herein above. At the end of the first stage, the bottom layer of glycerol byproduct is separated and removed, more methanol and base catalyst are added to the mixture comprising triglycerides and fatty acid esters, and heating of the reaction mixture is continued to produce a second reaction mixture comprising glycerol and a mixture of fatty acid esters. The removal of glycerol, addition of more methanol and base, and heating steps are repeated until the triglycerides contained in the HOS oil have been transesterified to fatty acid esters. In one embodiment, the reaction of HOS oil with the aliphatic monoalcohol is performed in two stages. In a two stage process, a total about 30 weight % of the monoalcohol and a total of about 0.1 wt % to about 1.0 wt %, for example about 0.1 wt % to about 0.5 wt %, of the base catalyst are used, based on the amount of HOS oil used.

After removal of glycerol and excess aliphatic monoalcohol, the resulting mixture of fatty acid esters can be used in the next step of the process without further treatment. The yield of this transesterification reaction is almost quantitative. Optionally, however, the mixture of fatty acid esters obtained can have some remaining glycerol and/or glycerol esters (triglycerides). In one embodiment there is less than 10% of glycerol and/or glycerol esters present in the mixture. In another embodiment there is less than 5%, or less than 3%, or less than 1% of glycerol and/or glycerol esters in the fatty acid ester mixture. In one embodiment the mixture of fatty acid esters is essentially free of glycerol and/or glycerol esters. The composition of the fatty acid moieties in the mixture of fatty acid esters corresponds to the composition of the fatty acid moieties of the HOS oil.

The fatty acid esters are then reacted with a polyol in the presence of a second base catalyst to produce a reaction mixture comprising the aliphatic monoalcohol used in the first synthesis step and a mixture of polyol esters containing the fatty acid moieties of the HOS oil. The second base catalyst can be selected from the same group of catalysts as the first catalyst, and can be the same as the first catalyst or different from the first catalyst. The polyol comprises pentaerythritol, trimethylolpropane, neopentyl glycol, or combinations thereof. This transesterification reaction can be driven to higher conversion by the use of a slight excess of the fatty acid esters of the HOS oil, for example from about 1.15 to about 1.5 equivalents in relation to the total hydroxyl groups of the polyol, and by the removal of the monoalcohol formed during the transesterification with the polyol. Optionally, unreacted fatty acid esters can be removed by distillation.

In one embodiment, the polyol comprises pentaerythritol, and the second synthetic step can be represented as shown in Scheme II below, where R¹, R², R³, and R⁴ have the same meanings as defined above. Note that in Scheme II only three fatty acid esters of the starting mixture are shown, although the mixture contains a variety of fatty acid esters such that the C16:0, C18:0, C18:1, C18:2, and C18:3 contents of the fatty acid moieties of the HOS oil described herein above are met. Furthermore, only one generalized polyol ester product is shown, although a mixture of pentaerythritol esters comprising the fatty acid moieties of the HOS oil are produced and R can be R¹, R², and R³, or any combination.

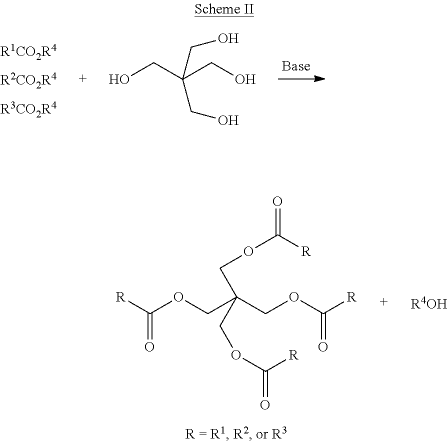

In one embodiment, the polyol comprises trimethylolpropane, and the second synthetic step can be represented as shown in Scheme III below, where R¹, R², R³, and R⁴ have the same meanings as defined above. Note that in Scheme III only three fatty acid esters of the starting mixture are shown, although the mixture contains a variety of fatty acid esters such that the C16:0, C18:0, C18:1, C18:2, and C18:3 contents of the fatty acid moieties of the HOS oil described herein above are met. Furthermore, only one generalized polyol ester product is shown, although a mixture of trimethylolpropane esters comprising the fatty acid moieties of the HOS oil are produced and R can be R¹, R², and R³, or any combination.

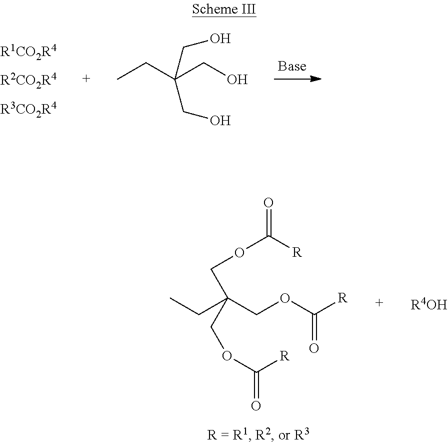

In one embodiment, the polyol comprises neopentyl glycol, and the second synthetic step can be represented as shown in Scheme IV below, where R¹, R², R³, and R⁴ have the same meanings as defined above. Note that in Scheme IV only three fatty acid esters of the starting mixture are shown, although the mixture contains a variety of fatty acid esters such that the C16:0, C18:0, C18:1, C18:2, and C18:3 contents of the fatty acid moieties of the HOS oil described herein above are met. Furthermore, only one generalized polyol ester product is shown, although a mixture of neopentyl glycol esters comprising the fatty acid moieties of the HOS oil are produced and R can be R¹, R², and R³ or any combination.

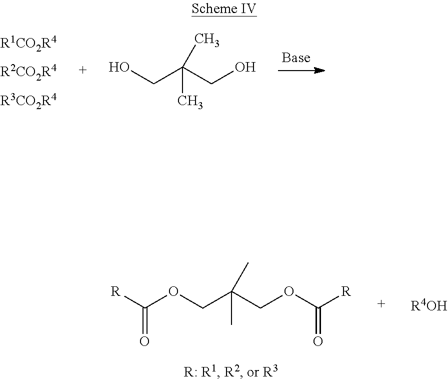

In any of the Schemes of the present invention the second base catalyst can be selected from the same group of catalysts as the first base catalyst, and can be the same as the first catalyst or different from the first catalyst. The second base catalyst can comprise sodium hydroxide, potassium hydroxide, lithium hydroxide, sodium methoxide, or combinations thereof, for example. In one embodiment, the second base catalyst comprises potassium hydroxide. Typically, the reaction temperature is slowly increased as the conversion to polyol esters proceeds, in order to avoid vigorous boiling of the monoalcohol byproduct and loss of the polyol while maintaining a high rate of reaction. The more volatile monoalcohol R⁴OH can be removed by distillation under reduced pressure. Suitable reaction conditions for reacting the fatty acid esters with the polyol include a reaction temperature from about 50° C. to about 200° C. and a reaction time from about 5 hours to about 150 hours under a vacuum in the range of 5 torr to about 100 torr. The preparation of pentaerythritol esters in high conversion may require higher temperature and longer reaction time.

After removal of the monoalcohol and optionally any unreacted fatty acid esters, the mixture of polyol esters can be separated from any higher-boiling by-products, for example by centrifuging the mixture and passing it through a thin layer of silica gel. The mixture of polyol esters can then be dried on full vacuum (0.5 torr or lower) at 110° C., typically for about 1 hour, to provide the final mixture of polyol esters.

Similarly, a mixture of polyol esters can be obtained from other vegetable oils, for example including but not limited to sunflower oil, canola oil, safflower oil, rapeseed oil, corn oil, olive oil, coconut oil, palm oil, castor oil, commodity soybean oil, high oleic sunflower oil, high oleic canola oil, and mixtures thereof. The characteristics of the mixture of polyol esters, for example the content of unsaturated and saturated moieties such as C18:1, C18:2, C13:3, C16:0, and C18:0 moieties, can reflect the composition of the vegetable oil(s) from which they are derived. Optionally, a mixture of polyol esters can be refined, for example by distillation, to separate one or more polyol esters from the mixture, or to enrich or deplete the mixture with respect to one or more of the polyol esters. In one embodiment of the process for preparing a mixture of polyol esters, the process further comprises providing at least one vegetable oil other than high oleic soybean oil in addition to the high oleic soybean oil.

IMC-130 Canola oil, available from Cargill, Inc., has an oleic acid content of about 75% and a polyunsaturated fatty acid content (C18:2 and C18:3) of about 14%. U.S. Pat. No. 5,767,338 describes plants and seeds of IMC-130. See also U.S. Pat. No. 5,861,187. High oleic sunflower oils having oleic acid contents, for example, of about 77% to about 81%, or about 86% to about 92%, can be obtained from A. G. Humko, Memphis Term. U.S. Pat. No. 4,627,192 describes high oleic acid sunflower oils.

The dielectric fluid may further comprise from about 1 wt % to about 70 wt %, for example from about 1 wt % to about 50 wt %, or from about 1 wt % to about 30 wt %, or from about 1 wt % to about 20 wt %, or from about 1 wt % to about 10 wt % of a blending component comprising other dielectric fluids such as vegetable oils, vegetable oil based fluids, a mixture of polyol esters derived from a reaction of a polyol and a mixture of fatty acid esters derived from a high oleic soybean oil, mineral oil, synthetic esters, silicon fluids and poly alpha olefins, based on the total weight of the dielectric fluid. In one embodiment, the dielectric fluid further comprises a blending component selected from the group consisting of vegetable oil, mineral oil, silicone fluids, synthetic esters, poly alpha olefins, or mixtures thereof.

The dielectric fluids can contain useful additives, for example antioxidants, metal passivators, metal deactivators, in particular copper deactivators, corrosion inhibitors, flame retardants, thermal stabilizers, viscosity modifiers, pour point depressants, anti-foaming agents, acid-base indicators, acid scavengers, plasticizers, and dyes, provided that the additives are soluble in the compositions, are thermally stable at high temperatures, and do not deleteriously affect the electrical properties of the dielectric fluid or the insulating material. In one embodiment, the dielectric fluid further comprises at least one additive selected from the group consisting of oxidation inhibitors, corrosion inhibitors, metal deactivators, acid scavengers, and pour point depressants.

Most common antioxidants are natural or synthetic phenols, hindered phenols, quinones, hydroquinones, and their derivatives. Examples of useful antioxidants that can be easily blended with vegetable oils include butylated hydroxyanisole (BHA), tertiary butyl hydroquinone (TBHQ), butylated hydroxyl toluene (BHT), hydroquinone monomethyl ether (MEHQ), Lonol® 926, Lonol® LC, ethoxyquin, phenothiazine, Irganox® 259, Chimassorb® 944, Irganox® 1330, Irganox® E201, pyrogallol, catechol, cathecin, methylhydroquinone, 4-methoxyphenol, 2-phenylhydroquinone, cathecin, methoxy hydroquinone, dimethoxy phenol, ascorbic acid, tocopherols, and tocotrienols. Antioxidants can be added to the dielectric fluid in an amount of from about 100 ppm to about 10,000 ppm, for example from about 500 ppm to about 5000 ppm, or from about 800 ppm to about 2500 ppm to prevent or reduce degradation of the dielectric fluid and/or the insulating material during use.

Generally pour point depressants can be, for example, acrylate or methacrylate copolymers, or esters such as stearyl methacrylate, isodecyl acrylate, butyl methacrylate, 2-ethylhexyl acrylate, and lauryl acrylate. The addition of pour point depressants can effectively reduce the pour point of a dielectric fluid and improves its low temperature fluidity. Examples of useful pour point depressants include Enerflow 107671A (Enertech Labs. Inc., Buffalo, N.Y.) Infineum V385, Infineum 387, (Oxfordshire, OX, United Kingdom), Aclube P-D3000, Aclube P-D4070 (Sanyo Chemicals, Tokyo, Japan). Pour point depressants can be added to the dielectric fluid in an amount of from about 1 wt % to about 15 wt %, or from about 1 wt % to about 10 wt %, or from about 1 wt % to about 5 wt %, based on the weight of the dielectric fluid.

Metal passivators and metal deactivators are generally organic materials containing heteroatoms such as nitrogen, oxygen, sulfur and disulfides which can bind to metal or metal oxide surfaces to provide a passivating, corrosion-inhibiting effect. There are also compounds which can slow down metal-catalyzed oxidation in the liquid phase by the formation of inactive metal chelates, which can reduce the unwanted dissolution of metals such as copper in electrical devices. Examples of suitable metal passivators and metal deactivators for use with dielectric fluids include disalicylidenediamines, anthranilic acid, benzotriazole and tolyltriazole.

Acid scavengers can be added to dielectric fluids to neutralize acids which may produced by thermal degradation of the dielectric fluid, so that the acids do not react with metals or the solid insulating material in an electrical apparatus such as a transformer. Examples of useful acid scavengers include hydrotalcites, metallic fatty acid esters (e.g. zinc stearate, calcium stearate, sodium 2-ethylhexanoate), epoxi esters, zeolites, ionic liquids, imidazoles, Hysafe®539, Sipax® AC-207, Hycite®713, Ceasit™ AV, Cardura E10P, and Basil™. Acid scavengers can be added to the dielectric fluid in an amount of from about 0.01 wt % to about 5 wt %, or from about 0.05 wt % to about 2 wt %, based on the weight of the dielectric fluid.

The insulating material disclosed herein is suitable for use in applications requiring electrical insulating material having the properties of the nonwoven webs disclosed herein, such as liquid-filled power transformers, distribution transformers, traction transformers, reactors, and their accessory equipment such as switches and tap changers, all of which are fluid-filled. The combination of dielectric fluid and solid insulating material comprising a nonwoven web as described herein provides electrical insulation for an electrical apparatus. In one embodiment, the electrical apparatus comprising the insulating material disclosed herein is an electrical transformer, an electrical capacitor, a fluid-filled transmission line, an electrical power cable, an electrical inductor, or a high voltage switch. In one embodiment, the electrical apparatus is a closed transformer. In one embodiment, the electrical apparatus is an open transformer having a headspace containing an inert gas. In one embodiment, a dielectric material comprises a nonwoven web as described herein impregnated with at least about 5 weight percent, or at least about 10 weight percent, or at least about 15 weight percent, or at least about 20 weight percent of a dielectric fluid. The dielectric material can be impregnated with the dielectric fluid such that it is saturated with the dielectric fluid. In one embodiment, the nonwoven web has a tensile strength retention at rupture in the machine direction of at least about 70% after about 4 weeks of immersion in vegetable oil at about 160° C. In one embodiment, the nonwoven web has an elongation retention in the machine direction of at least about 55% after about 4 weeks of immersion in vegetable oil at about 160° C.

When used as inexpensive insulating material for a liquid filled transformer, the nonwoven webs disclosed herein can provide longer term benefit to both the manufacturer and the consumer, since the nonwoven webs can maintain high tensile strength, and in turn provide extended lifetime for a transformer. Advantageously, the nonwoven webs do not release water during aging, unlike cellulosic insulating material. Also, the nonwoven webs can maintain good flexibility and elastic properties, while cellulosic insulating material can become brittle during degradation; the small floating byproducts of cellulosic degradation can cause dielectric failure of a transformer.

It is believed that the insulating material disclosed herein would also perform well in dry transformers, in which the dielectric medium is air.

Certain additives such as antioxidants, pour point depressants, acid scavengers, and plasticizers, may further improve the thermal capability of the dielectric fluid and at the same time may have a positive effect on the mechanical performance of the nonwoven web, insulating material comprising the nonwoven web, and dielectric material comprising the nonwoven web.

The insulating material, dielectric apparatus, and dielectric material disclosed herein can further comprise Kraft paper and/or thermally upgraded Kraft paper. The combination of a nonwoven web comprising a plurality of continuous spunbonded polyester bicomponent fibers, wherein each of the plurality of bicomponent fibers comprises from about 20% by weight to about 80% by weight of poly(ethylene terephthalate) in a core, and from about 80% by weight to about 20% by weight of poly(trimethylene terephathalate) in a sheath surrounding the core, with Kraft paper and/or thermally upgraded Kraft paper can be advantageous by providing the required electrical characteristics at lower cost. In one embodiment, a nonwoven web and Kraft paper and/or thermally upgraded Kraft paper may be used to provide multilayered wrapping of the transformer coil and core, connectors, and wires. In one embodiment, a nonwoven web may be used to wrap the initial layers around a mostly cylindrical part of the transformer and Kraft paper and/or thermally upgraded Kraft paper may be used to wrap additional layers; use of the nonwoven web may provide higher tear resistance and better conformability to the curvature radius. In one embodiment, the insulation of the transformer may comprise layers of nonwoven web and Kraft paper and/or thermally upgraded Kraft paper; the nonwoven web or the Kraft paper may be used as the first or last layer, depending on the gradient of heat and magnetic flux generated in the transformer. In one embodiment, the insulation around the transformer may comprise Kraft paper and/or thermally ugraded Kraft paper, and the mechanically-stronger nonwoven web may be used as an outer layer over the Kraft paper to protect it. In one embodiment, a combination of nonwoven web and Kraft paper and/or thermally upgraded Kraft paper may be used to control the permeation of the dielectric fluid through the insulation, and the material with lower permeation may be placed against the higher temperature surface of the transformer to provide better fluidity of the dielectric fluid.

### EXAMPLES

The following materials were used in the examples. All commercial reagents were used as received unless otherwise noted.

Refined, bleached, and deodorized high oleic soybean oil (RBD HOS oil, referred to herein as “HOS oil”) containing triglycerides of the following fatty acids: palmitic acid (6.5 wt %), stearic acid (4.15 wt %), oleic acid (73.9 wt %), linoleic acid (8.77 wt %), and linolenic acid (2.94 wt %) was obtained according to U.S. Pat. No. 5,981,781. The oil was carefully dried by rotovap at 90° C. for 4 hours with application of 50 mTorr vacuum.

Commercially available mineral oil UNIVOLT N 61 B (ExxonMobil, Fairfax Va.) was used as received without drying prior to the accelerated stability tests. UNIVOLT N 61 B can be described as hydrotreated light naphthenic distillate (petroleum). It is referred to as “mineral oil” in the Examples and Comparative Examples in which it was used.

Commercially available Kraft paper and commercially available thermally upgraded Kraft paper (22HCC) were obtained from Weidmann Electrical Technology Inc. (St. Johnsbury, Vt.). Epoxidized soybean oil, (Vicoflex 7170) was obtained from Arkema Inc., (Blooming Pairie, Minn.). Tertiary butyl hydroquinone (TBHQ, 95%, cat.#112941), catechin, and epoxidized soybean acrylates (cat.#412333) were obtained from Aldrich (St. Louis, Mo.). Irganox 259 was obtained from Ciba Specialty Chemicals Inc. (Tarrytown, N.Y.). N,N′-Bis(salicylidene)-1,2-propanediamine was obtained from TCI (America, (Portland, Oreg.). Copper chips were obtained from A.J.Oster Foils, (Alliance, Ohio). Stearyl methacrylate, isodecyl acrylate, butyl methacrylate, 2-ethylhexyl acrylate, lauryl methacrylate, and Vazo® 64 were purchased from Aldrich (sigmaaldrich.com). Toluene was obtained from EDM (edmchemicals.com).

### Preparation of Spunbond Nonwoven Webs

Nonwoven webs comprising bicomponent fibers were made from a poly(ethylene terephthalate) (PET) component and a poly(trimethylene terephthalate) (PTT) component. The PET component was obtained from Dupont Company (Old Hickory, Tenn.) as PET resin grade 4434 and had an intrinsic viscosity (IV) of 0.67 dl/g. The PTT component, D13454709 Sorona® J2241 semi-dull is also available from Dupont Company (Wilmington, Del.). The PTT used had an IV of 1.02 dl/g; Mn ˜28000; and about 37% renewably sourced ingredients by weight

Both the PET resin and the PTT resin were dried in a through air dryer at a temperature of 100° C. to a moisture content of less than 50 ppm.

A bicomponent spinning system, Model # NF5, manufactured by Nordson Fiber Systems Inc. (Duluth, Ga.) and Hills Inc. (W. Melbourne, Fla.) was used for creating the spunbond structures. The two components were separately extruded and metered to a spin-pack assembly, where the two melt streams were separately filtered and then combined through a stack of distribution plates to provide multiple rows of sheath-core fiber cross-sections. The spin-pack assembly consisted of a total of 1162 round capillary openings. The width of the forming zone was 56 cm. The spin-pack assembly was heated to 295° C. The PTT and PET polymers were spun through the each capillary at a polymer throughput rate of 1.0 g/hole/min.

The bundle of fibers was cooled in a cross-flow quench extending over a length of 75 cm. An attenuating force was provided to the bundle of fibers by a rectangular slot jet. The distance between the spin-pack to the entrance to the jet was 63 cm.

The fibers exiting the jet were collected on a forming belt. Vacuum was applied underneath the belt to help pin the fibers to the belt. The fibers were then thermally bonded in a nip formed between two smooth metal rolls, both rolls being heated to 155° C., with a nip pressure of 714 N/cm. The thermally bonded sheet was then wound onto a roll.

The speed of the belt was varied to obtain spunbonds of various basis weights. The belt speed was set at 42 m/min to obtain 50 gsm spunbond. It was slowed down to 21 m/min to obtain 100 gsm sheet and was further slowed to 14 m/min to obtain 150 gsm sheet.

Basis Weight is a measure of the mass per unit area of a web or sheet and was determined by ASTM C-3776 and is reported in g/m², abbreviated as gsm.

Table NW-1 summarizes the bicomponent spunbond nonwoven webs' composition and basis weight. The sheath and the core comprise one polymeric component each, either PTT or PET. Hence, for the spunbond nonwoven web referred to as 1, 50 weight % PTT in the sheath and 50 weight % PET in the core means that the sheath comprises pure PTT and the core comprises pure PET, such that the weight ratio of sheath to core is 50:50. For the spunbond nonwoven web referred to as 2, 25 weight % PTT in the sheath and 75 weight % PET in the core means that the sheath comprises pure PTT and the core comprises pure PET, such that the weight ratio of sheath to core is 25:75. Samples of nonwoven web 1 having a basis weight of 50 gsm are referred to herein as nonwoven web 1-1; samples of nonwoven web 1 having a basis weight of 100 gsm are referred to herein as nonwoven web 1-2; samples of nonwoven web 1 having a basis weight of 150 gsm are referred to herein as nonwoven web 1-3. Similarly, samples of nonwoven web 2 having a basis weight of 50, 100, or 150 gsm are referred to herein as nonwoven web 2-1, 2-2, and 2-3, respectively.

TABLE NW-1
Composition of Exemplary Bicomponent Spunbond
Webs

| | | |
|---|---|---|
| | Composition (weight % | |
| Spunbond | based on the total | Basis |
| Nonwoven | weight of the fiber) | weight |

| | | | |
|---|---|---|---|
| Web | Sheath | Core | (gsm) |

| | | | | |
|---|---|---|---|---|
| 1 | 1-1 | 50% PTT | 50% PET | 50 |
| | 1-2 | 50% PTT | 50% PET | 100 |
| | 1-3 | 50% PTT | 50% PET | 150 |
| 2 | 2-1 | 25% PTT | 75% PET | 50 |
| | 2-2 | 25% PTT | 75% PET | 100 |
| | 2-3 | 25% PTT | 75% PET | 150 |

### Measurement of Nonwoven Web Strength and Wear

The spunbond nonwoven webs 1 and 2 were tested for strength (Grab tear, Trapezoidal tear, Strip tensile and Mullen burst) using the following standard ASTM (American Society for Testing and Materials) methods for nonwovens as follows:

Strip Tensile strength is a measure of the breaking strength of a sheet and was conducted on a 2.54-cm (1-inch) wide strip according to ASTM D1117-01, D5035-95, and is reported in Table NW-2.

TABLE NW-2
Strip Tensile Strength of Exemplary Bicomponent
Spunbond Webs

| | | Strip Tensile, MD | | | Strip Tensile, XD | | |
|---|---|---|---|---|---|---|---|
| | | | | Load/ | | | Load/ |
| Basis | | | | basis | | | basis |
| Weight | | Load | Strain | weight | Load | Strain | weight |
| (gsm) | Sample # | (N) | (%) | (N/gsm) | (N) | (%) | (N/gsm) |
| 50 | 1-1 | 54.47 | 50.23 | 1.0894 | 51.21 | 57.95 | 1.0242 |
| 50 | 2-1 | 64.17 | 58.24 | 1.2834 | 43.69 | 52.62 | 0.8738 |
| 100 | 1-2 | 90.94 | 36.6 | 0.9094 | 81.7 | 54.77 | 0.8170 |
| 100 | 2-2 | 133.99 | 59.89 | 1.3399 | 125.05 | 77 | 1.2505 |
| 150 | 1-3 | 174.94 | 52.44 | 1.1663 | 168.89 | 73.52 | 1.1259 |
| 150 | 2-3 | 257.75 | 85.31 | 1.7183 | 205.88 | 82.68 | 1.3725 |

Table NW-2 suggests that at 100 gsm and 150 gsm, the spunbond webs containing 25 weight % PTT in the sheath (Samples 2-2 and 2-3) are stronger than those containing 50 weight % PTT in the sheath (Samples 1-2 and 1-3).

Mullen burst test measures the pressure required to burst a web and was conducted according to ASTM D1117-01, D5035-95 and is reported in units of force per unit area KPa in Table NW-3.

TABLE NW-3
Mullen burst test results of Exemplary Bicomponent
Spunbond Webs

| | | Mullen burst | Mullen burst/basis |
|---|---|---|---|
| [Basis weight (gsm) | Sample # | (KPa) | weight (KPa/gsm) |
| 50 | 1-1 | 267.53 | 5.3506 |
| 50 | 2-1 | 260.63 | 5.2126 |
| 100 | 1-2 | 479.89 | 4.7989 |
| 100 | 2-2 | 619.17 | 6.1917 |
| 150 | 1-3 | 714.322 | 4.7621 |
| 150 | 2-3 | >827.4 | — |

At 150 gsm, the Mullen burst of Sample 2-3 (PTT in the sheath) could not be measured as it was beyond the instrument limit.

Grab tear strength is a measure of force required to tear a piece of web into two pieces. Grab tear strength is based on the breaking strength of the individual threads of the web working in conjunction with each other. Grab tear was conducted according to ASTM D1117-01, D5035-95 in two directions: machine direction (MD) and perpendicular to the machine direction (XD) and is reported in Newton. Results are summarized in Table NW-4.

TABLE NW-4
Grab tear test of Exemplary Bicomponent Spunbond
Webs

| | | Grab Tear | | | Grab Tear | | |
|---|---|---|---|---|---|---|---|
| | | Strength, MD | | | Strength, XD | | |
| | | | | Load/ | | | Load/ |
| Basis | | | | basis | | | basis |
| Weight | | Load | Strain | weight | Load | Strain | weight |
| (gsm) | Sample # | (N) | (%) | (N/gsm) | (N) | (%) | (N/gsm) |
| 50 | 1-1 | 141.4 | 28.73 | 2.8280 | 141.4 | 46.51 | 2.8280 |
| 50 | 2-1 | 141.95 | 30.6 | 2.8390 | 126.78 | 44.93 | 2.5356 |
| 100 | 1-2 | 298.89 | 35.28 | 2.9889 | 297.2 | 55.01 | 2.9720 |
| 100 | 2-2 | 413.42 | 52.06 | 4.1342 | 337.51 | 53.22 | 3.3751 |
| 150 | 1-3 | 534.25 | 39.82 | 3.5617 | 495.36 | 52.85 | 3.3024 |
| 150 | 2-3 | 693.58 | 58.03 | 4.6239 | 618.28 | 68.47 | 4.1219 |

Table NW-4 suggests that at 100 gsm and 150 gsm, the spunbond webs containing 25 weight % PTT in the sheath (Samples 2-2 and 2-3) are stronger than those containing 50 weight % PTT in the sheath (Samples 1-2 and 1-3).

Trapezoidal tear strength is a measure of ability to resist a continued tear. The test specimen is trapezoid in shape. A slit is made in the sample for the tear and effort required to continue the tear across the web is measured. Trapezoidal tear was conducted according to ASTM 5733. Results are summarized in Table NW-5.

TABLE NW-5
Trapezoidal tear of Exemplary Bicomponent Spunbond Webs

| | | Trapezoidal tear, | Trapezoidal tear/basis |
|---|---|---|---|
| Basis weight | | MD | weight, MD |
| (gsm) | Sample # | (KPa) | (KPa/gsm) |
| 50 | 1-1 | 267.53 | 5.3506 |
| 50 | 2-1 | 260.63 | 5.2126 |
| 100 | 1-2 | 479.89 | 4.7989 |
| 100 | 2-2 | 619.17 | 6.1917 |
| 150 | 1-3 | 714.322 | 4.7621 |
| 150 | 2-3 | >827.4 | — |

Accelerated ageing studies were performed using spunbonded nonwoven webs 1-2 and 2-2, each of 100 gsm basis weight, which were also point-bonded. Nonwoven web 1-2 comprised 50 weight % PTT in the sheath and 50 weight % PET in the core, such that the weight ratio of sheath to core was 50:50. Nonwoven web 2-2 comprised 25 weight % PTT in the sheath and 75 weight % PET in the core, such that the weight ratio of sheath to core was 25:75. The thickness of each web sample is indicated in the Tables of results. The nonwoven webs were tested in vegetable oil (HOS oil) with and without additives and in mineral oil as described in the following Examples and Comparative Examples. The nonwoven webs were dried in an oven for 24 hours at 110° C. before use in the accelerated ageing studies.

The following test methods were used in the Examples provided below.

Water content of high oleic soybean oil samples was determined using the volumetric Karl Fischer titration method (EMD Aquastar AQV33, EMD CombiTittrant 5 in 50:50 Methanol Toluene solvent). Typically, the moisture content of the high oleic soybean oil was about 160 ppm water after drying. Water content of mineral oil UNIVOLT N 61 B was determined by the same method. The mineral oil typically contained about 30 ppm water.

Tensile and elongation properties were measured for the nonwoven webs of Examples 1-25 according to ASTM D828-97 on 2.54 cm (1 inch) wide and 12.70 cm long (5 inch) specimen with Instron Model 1125 (Instron Corporation, Canton, Mass.), with modified MTS Corporation Testworks 4 Software. In Examples 26-28 and Comparative Examples G, H, I, and J tensile properties and elongation were measured according to ASTM D828-97 on 2.54 cm (1 inch) wide and 10.16 cm long (4 inch) specimens with 4 repeats on Instron Model 1122/8500R with flat-face grips (Instron Corporation, Canton, Mass.) and Bluehill software. Excess oil was wiped off the nonwoven samples prior to measurement of the tensile and elongation properties.

The tensile strength retention of the aged nonwoven webs was calculated as follows:

$$tensile retention ( \% ) = \frac{Tensile stength of aged sample}{Tensile stength of reference sample} \times 100$$

Similarly, the elongation at break retention (in the machine or in the cross direction) was calculated as follows:

$$elongation retention ( \% ) = \frac{Elongation at break of aged sample}{Elongation at break of reference sample} \times 100$$

The thickness of Kraft paper, thermally upgraded Kraft paper, and nonwoven web was measured by caliper in millimeters and converted to microns.

For Examples 1 through 24 and Comparative Examples A through J, accelerated ageing studies were performed at 160° C. or at 180° C. or at 200° C. for 4 weeks (672 hours), 8 weeks (1344 hours), or 16 weeks (2688 hours) to determine the effects of exposure to a dielectric fluid at high temperature on the nonwoven web insulating material and to estimate the potential expected lifetime of the material in a liquid filled transformer. The nonwoven web samples, the glass test tubes and the oil were carefully dried prior to the tests. The nonwoven webs were dried in an oven for 24 hours at 110° C. The glass containers were dried at 550° C. for 24 hours, cooled to room temperature, loaded with the nonwoven web and the oil, and then sealed in a nitrogen atmosphere. Each tube was filled with about 84 cm³ oil, the average nonwoven sample weight was 1.8 g, and the head space was about 30-39 cm³. The test tubes containing the nonwoven samples immersed in oil (with or without additives) were placed into an oven maintained at the desired temperature. After the desired 4, 8, or 16 weeks of ageing, the tests tubes were removed from the oven, the excess oil was wiped off the nonwoven web samples, and physical measurements were performed on the aged test specimen. Separate nonwoven samples were used for the 4, 8, and 16 week ageing tests.

For Examples 25 and 26 and Comparative Examples K and L, accelerated ageing studies were performed as described above except with the following differences. The temperature was 200° C. for between 2 days (48 hours) and 4 weeks (672 hours). Before performing the ageing studies, the nonwoven web 2-2 samples were dried in glass tubes at 115° C. under −80 kPa vacuum for 24 hours, then 85 g of oil was added and the oil/nonwoven mixture was further dried under the same conditions for 8 hours before being cooled under N₂ (16 hours) to room temperature. The glass tubes were exposed to air and then sealed with a headspace of about 20 cm³.

Porosimetry—Nitrogen adsorption/desorption measurements were performed at 77.3 K as defined in ASTM D4641 (Micrometrics ASAP model 2400 porosimeter, Atlanta Ga.). Compressibility was corrected for by performing Mercury porosimetry as defined in L. Abrams et. al, Tappi Proceedings 1996 Coating Conference, p 185-192 (Micrometrics Autopore model 9220 porosimeter, Atlanta Ga.) and corrected skeletal density, compressibility, intrusion volume and surface area shown.

Alternating Current Dielectric Strength (ACDS) was measured according to ASTM D149. Samples were pre-treated by heating under vacuum (115° C., <5 Torr) for 24 hours, then heated submerged in mineral oil under nitrogen (115° C.) for 8 hours, and cooled under nitrogen for 16 hours. Testing was performed at 23° C. using a 2″ electrode of ¼″ radius on Phenix 6TCE4100/50-5/D149X.

### Comparative Example A

Kraft paper which had not been immersed in any oil was cut into pieces (2.5 cm×7.5 cm) and the tensile properties measured. Results are shown in Tables 1 and 2.

### Comparative Example B

Kraft paper was cut into pieces (2.5 cm×7.5 cm) and placed into a glass container which was then filled with high oleic soybean oil (HOS oil). The container was placed into an oven at 160° C. for 2 weeks (336 hours). The container was removed, cooled, and the excess oil wiped from the paper samples before the tensile properties were measured. Results are shown in Tables 1 and 2.

### Comparative Example C

Comparative Example C was performed the same way as Comparative Example B, except that mineral oil was used instead of HOS oil. Results are shown in Table 2.

### Comparative Example D

Thermally upgraded Kraft paper which had not been immersed in any oil was cut into pieces (2.5 cm×7.5 cm) and the tensile properties measured. Results are shown in Tables 1 and 2.

### Comparative Example E

Thermally upgraded Kraft paper was cut into pieces (2.5 cm×7.5 cm) and placed into a glass container which was then filled with HOS oil.

The container was placed into an oven at 160° C. for 2 weeks (336 hours). Then the container was removed, cooled, and the excess oil wiped from the paper samples before the tensile properties were measured. Results are shown in Tables 1 and 2.

### Comparative Example F

Comparative Example F was performed the same way as Comparative Example E, except that mineral oil was used instead of HOS oil. Results are shown in Table 2.

### Example 1

Strips of spunbonded nonwoven web 1-2 which had not been immersed in any oil were used as “dry” control samples. The tensile properties of the nonwoven web were measured in the machine direction (MD) and in the cross or transverse direction (XD). Results are shown in Table 1.

### Example 2

Strips of spunbonded nonwoven web 1-2 were immersed in HOS oil containing 10 wt % epoxidized soybean oil as an additive. After 24 hours at room temperature, the excess oil was wiped off the nonwoven web samples and the tensile properties were measured. Results are shown in Table 1.

### Example 3

Strips of spunbonded nonwoven web 1-2 were immersed in HOS oil for 4 weeks (672 hours) at 160° C. At that time the samples were removed from the oven, and the tensile properties were measured. Results are shown in Table 1.

### Example 4

Strips of spunbonded nonwoven web 1-2 were immersed in HOS oil containing 10 wt % epoxidized soybean oil as an additive at 160° C. for 4 weeks (672 hours). Tensile properties are shown in Table 1.

TABLE 1
Tensile Properties of Selected Comparative Examples (Papers)
and Examples 1-4 (Nonwoven Webs Comprising 50 wt % PTT in the
Sheath and 50 wt % PET in the Core)

| | | | | Tensile | | Tensile | | | | | |
|---|---|---|---|---|---|---|---|---|---|---|---|
| | | | | Strength | | Strength | | | | | |
| | | | | @ | | @ | | | Elongation | Elongation | Elongation |
| | | | | Rupture | Tensile | Rupture | Tensile | Elongation | @ | @ | @ |
| | | | | (MD) | Strength | (XD) | Strength | @ Break | Break | Break | Break |
| | | Ageing | Thickeness | N/cm | Retention | N/cm | Retention | (MD) | Retention | (XD) | Retention |
| | Liquid | Time | (MD) | (Std. | (MD) | (Std. | (XD) | % | (MD) | % | (XD) |
| Example | Media | hr | μm | Dev.) | % | Dev.) | % | (Std. Dev.) | % | (Std. Dev.) | % |
| Comparative | none | n/a | 88 | 90.7 (+/−) | n/a | 14.5 (+/− | n/a | 21.1 (+/− | n/a | 8.5 (+/−) | n/a |
| Example A | | | | 2.0) | | 0.5) | | 0.6) | | 0.6) | |
| Comparative | HOS oil | 336 | 83 | 28.7 (+/−) | 31.6 | 17.2 (+/− | 118.6 | 4.8 (+/−0.9) | 22.7 | 1.3 (+/− | 15.3 |
| Example B+ | | | | 0.5) | | 0.5) | | | | 0.4) | |
| Comparative | none | n/a | 88 | 94.2 (+/− | n/a | 14.6 (+/− | n/a | 27.3 (+/− | n/a | 8.7 (+/− | n/a |
| Example D | | | | 2.7) | | 0.4) | | 1.0) | | 0.9) | |
| Comparative | HOS oil | 336 | 80 | 31.9 (+/− | 33.9 | 18.6 (+/− | 127.4 | 3.6 (+/−0.9) | 13.2 | 1.4 (+/− | 16.1 |
| Example E# | | | | 0.9) | | 0.5) | | | | 0.2) | |
| Example 1 | none | n/a | ~250 | 39.9 | n/a | 38.5 | n/a | 31.2 | n/a | 44.1 | n/a |
| | | | | (+/−3.2) | | (+/−0.6) | | (+/−5.2) | | (+/−3.9) | |
| Example 2 | HOS oil + | 24 | 270 | 42.7 | n/a | 35.2 | n/a | 45.4 | n/a | 57.5 | n/a |
| | 10% | | | (+/−3.9) | | (+/−2.1) | | (+/−9.9) | | (+/−0.5) | |
| | epoxidized | | | | | | | | | | |
| | soybean | | | | | | | | | | |
| | oil | | | | | | | | | | |
| Example 3* | HOS oil, | 672 | ~250 | 28.5 | 71.4 | 31.3 | 81.3 | 17.9 | 57.4 | 19.8 | 44.9 |
| | no | | | (+/−0.5) | | (+/−0.4) | | (+/−3.9) | | (+/−3.5) | |
| | additives | | | | | | | | | | |
| Example 4** | HOS oil + | 672 | 243 | 40.8 | 95.6 | 33.6 | 95.5 | 32.5 | 71.6 | 38.2 | 66.4 |
| | 10 wt % | | | (+/−4.5) | | (+/−3.3) | | (+/−16.4) | | (+/−5.2) | |
| | epoxidized | | | | | | | | | | |
| | soybean | | | | | | | | | | |
| | oil | | | | | | | | | | |

Note:
Percent retention values were calculated relative to the following samples:
+values for Comparative Example B were calculated relative to Comparative Example A
#values for Comparative Example E were calculated relative to Comparative Example D
*values for Example 3 were calculated relative to Example 1
**values for Example 4 were calculated relative to Example 2

As the results in Table 1 show, the tensile strength retention in the machine direction of Kraft paper (Comparative Example B) was about 32% and that of thermally upgraded Kraft paper (Comparative Example E) was about 34% after 2 weeks of thermal aging in HOS oil at 160° C. In contrast, the nonwoven webs of Examples 3 and 4 both showed greater than about 70% tensile retention in the machine direction even after 4 weeks of aging at 160° C. The data for Example 4 showed that the addition of 10 wt % epoxidized soybean oil to the dielectric fluid improved the tensile strength retention and elongation retention of the nonwoven web both in the machine direction and in the cross direction.

### Example 5

Strips of spunbonded nonwoven web 2-2 which had not been immersed in any oil were used as “dry” control samples. The tensile properties of the nonwoven web were measured in the machine direction (MD) and in the cross-section (XD). Results are shown in Table 2.

### Example 6

Strips of spunbonded nonwoven web 2-2 were immersed in HOS oil containing 10 wt % epoxidized soybean oil as an additive. After 24 hours at room temperature, the tensile properties were measured. Results are shown in Table 2.

### Example 7

Strips of spunbonded nonwoven web 2-2 were immersed in HOS oil at 160° C. for 4 weeks (672 hours). Tensile properties are shown in Table 2.

### Example 8

Strips of spunbonded nonwoven web 2-2 were immersed in HOS oil containing as additives 10 wt % epoxidized soybean oil, 1000 ppm of TBHQ, and 1000 ppm of catechin. After 4 weeks (672 hours) at 160° C., the tensile properties were measured. Results are shown in Table 2

### Example 9

Strips of spunbonded nonwoven web 2-2 were immersed in HOS oil containing as additives 10 wt % epoxidized soybean oil, 1000 ppm of TBHQ, and 1000 ppm of catechin. After 8 weeks (1344 hours) at 160° C., the tensile properties were measured. Results are shown in Table 2.

### Example 10

Strips of spunbonded nonwoven web 2-2 were immersed in HOS oil containing 10 wt % epoxidized soybean oil as an additive at 160° C. for 4 weeks (672 hours). Tensile properties are shown in Table 2.

### Example 11

Strips of spunbonded nonwoven web 2-2 were immersed in HOS oil containing 10 wt % epoxidized soybean oil as an additive at 160° C. for 8 weeks (1344 hours). Tensile properties are shown in Table 2.

### Example 12

Strips of spunbonded nonwoven web 2-2 were immersed in mineral oil and tested at 160° C. for 2 weeks (336 hours). Tensile properties are shown in Table 2.

TABLE 2
Tensile Properties of Comparative Examples A-F (Papers) and
Examples 5-12

| | | | | Tensile | | Tensile | | | | | |
|---|---|---|---|---|---|---|---|---|---|---|---|
| | | | | Strength | | Strength | | | | | |
| | | | | @ | | @ | | | | | |
| | | | | Rupture, | Tensile | Rupture | Tensile | Elongation | Elongation | Elongation | Elongation |
| | | | | (MD) | Strength | (XD) | Strength | @ Break | @ Break | @ Break | @ Break |
| | | Ageing | Thickness | N/cm | retention | N/cm | Retention | (MD) | Retention | (XD) | Retention |
| | Liquid | Time | (MD) | (Std. | (MD) | (Std. | (XD) | % | (MD) | % | (XD) |
| Example | Media | hr | μm | Dev.) | % | Dev.) | % | (Std. Dev.) | % | (Std. Dev.) | % |
| Comparative | None | n/a | 88 | 90.7 | n/a | 14.5 | n/a | 21.1 (+/− | n/a | 8.5 (+/− | n/a |
| Example A | | | | (+/−) 2.0) | | (+/−0.5) | | 0.6) | | 0.6) | |
| Comparative | HOS oil | 336 | 83 | 28.7 | 31.6 | 17.2 | 118.6 | 4.8 (+/− | 22.7 | 1.3 (+/− | 15.3 |
| Example B+ | | | | (+/−) 0.5) | | (+/−0.5) | | 0.9) | | 0.1) | |
| Comparative | Mineral | 336 | 82 | 34.0 (+/− | 37.5 | 17.1(+/− | 117.9 | 8.6 (+/− | 40.8 | 1.6 (+/− | 18.8 |
| Example C+ | oil | | | 1.1) | | 0.8) | | 1.3) | | 0.2) | |
| Comparative | None | n/a | 88 | 94.2 | n/a | 17.0 | n/a | 27.3 (+/− | n/a | 8.7 (+/− | n/a |
| Example D | | | | (+/−2.7) | | (+/−0.4) | | 1.0) | | 0.9) | |
| Comparative | HOS oil | 336 | 80 | 31.9 | 33.9 | 18.6 | 109.4 | 3.6 (+/− | 13.2 | 1.4 (+/− | 16.1 |
| Example E# | | | | (+/−0.9) | | (+/−0.5) | | 0.9) | | 0.2) | |
| Comparative | Mineral | 336 | 80 | 34.2 (+/− | 36.3 | 19.6 (+/− | 115.3 | 4.8 (+/− | 17.6 | 1.9(+/−0.1) | 21.8 |
| Example F# | oil | | | 0.8) | | 0.3) | | 0.6) | | | |
| Example 5 | none | n/a | 250 | 51.8 | n/a | 39.9 | n/a | 42.3 | n/a | 36.8 | n/a |
| | | | | (+/−2.7) | | (+/−1.0) | | (+/−4.7) | | (+/−4.6) | |
| Example 6 | HOS2\hat{ } | 24 | 273 | 41.7 | n/a | 40.1 | n/a | 50.0 | n/a | 53.8 | n/a |
| | | | | (+/−4.2) | | (+/−2.1) | | (+/−0.4) | | (+/−6.0) | |
| Example 7** | HOS oil | 672 | 250 | 43.8 | 84.6 | 33.6 | 84.2 | 40.5 | 95.7 | 23.8 | 64.7 |
| | | | | (+/−1.0) | | (+/−1.1) | | (+/−6.7) | | (+/−8.1) | |
| Example 8* | HOS1^{@}, | 672 | 280 | 41.7 (+/− | 80.5 | 35.9 | 104.6 | 25.6 (+/− | 60.5 | 22.9 (+/− | 62.2 |
| | TBHQ | | | 2.7) | 100.0 | (+/−1.6) | | 5.4) | 51.2 | 4.1) | 42.6 |
| | and | | | | | | | | | | |
| | catechin | | | | | | | | | | |
| Example 9* | HOS1, | 1344 | 285 | 34.1 (+/− | 65.8 | 29.9 (+/− | 74.9 | 7.1 (+/− | 16.8 | 9.2 (+/− | 25.0 |
| | TBHQ | | | 2.5) | 81.8 | 2.2) | 74.6 | 1.8) | 14.2 | 1.4) | 17.1 |
| | and | | | | | | | | | | |
| | catechin | | | | | | | | | | |
| Example 10* | HOS2 | 672 | 273 | 49.7 | 95.9 | 43.9 | 110.0 | 42.0 | 99.3 | 45.9 | 124.7 |
| | | | | (+/−3.3) | 119.2 | (+/−2.4) | 109.5 | (+/−4.2) | 84.0 | (+/−7.4) | 85.3 |
| Example 11* | HOS 2 | 1344 | 263 | 48.8 | 94.2 | 39.7 | 99.5 | 45.0 | 106.7 | 37.1 | 100.8 |
| | | | | (+/−5.9) | 117.0 | (+/−2.9) | 99.0 | (+/−9.2) | 90.0 | (+/−4.0) | 69.0 |
| Example | Mineral | 336 | 250 | 12.8 (+/− | 24.7 | 9.5 (+/− | 23.8 | 0.82 (+/− | 1.9 | 0.84 (+/− | 2.3 |
| 12** | oil | | | 1.5) | | 1.1) | | 0.1) | | 0.1) | |

Note:
Percent retention values were calculated relative to the following samples: + values for Comparative Examples B and C were calculated relative to Comparative Example A
^{#}values for Comparative Examples E and F were calculated relative to Comparative Example D
*values for Examples 8, 9, 10, and 11 were calculated relative to Example 6
**values for Examples 7 and 12 were calculated relative to Example 5
^{@}HOS1 = HOS oil + epoxidized soybean oil
\hat{ }HOS2 = HOS oil + 10% epoxidized soybean oil

As the results in Table 2 show, the tensile strength retention of the nonwoven webs after immersion in HOS oil at 160° C. was very good after 4 weeks, even without any additives to the dielectric fluid. Example 7 had much better tensile strength retention (84.6%) after 4 weeks of aging while Comparative Example B had 31.6% retention and Comparative Example E had 33.9% tensile strength retention after 2 weeks of aging in HOS oil. Webs immersed for 4 weeks in HOS oil containing additives had very good and improved tensile strength retention in the machine direction, at least about 80% retention (Example 8) and higher, compared to that of Kraft paper (Comparative Example B, 31% retention) and thermally upgraded Kraft paper (Comparative Example E, 34% retention) after two weeks of thermal aging in HOS oil at the same temperature. Webs immersed for 8 weeks in HOS oil containing additives showed at least about 65% (Example 9) retention of tensile strength in the machine direction. Example 12 shows the mechanical properties of the nonwoven web after immersion in mineral oil for 2 weeks. In Table 2, in some cases the calculated percent retention was more than 100%, potentially due to non-uniformity in the thickness of the papers or nonwoven webs.

### Comparative Example G

Using Kraft paper, Comparative Example G was performed the same way as Comparative Example B, except that the temperature was 180° C. Data are shown in Table 3.

### Comparative Example H

Using Kraft paper, Comparative Example H was performed the same way as Comparative Example B, except that mineral oil was used instead of HOS oil and the temperature was 180° C. Data are shown in Table 3.

### Comparative Example I

Using thermally upgraded Kraft paper, Comparative Example I was performed the same way as Comparative Example E, except that the temperature was 180° C. Data are shown in Table 3.

### Comparative Example J

Using thermally upgraded Kraft paper, Comparative Example J was performed the same way as Comparative Example E, except that mineral oil was used instead of HOS oil and the temperature was 180° C. Data are shown in Table 3.

### Example 13

Strips of spunbonded nonwoven web 2-2 were immersed in HOS oil at 180° C. for 2 weeks (336 hours). Tensile properties are shown in Table 3.

### Example 14

Strips of spunbonded nonwoven web 2-2 were immersed in HOS oil containing as additive 2000 ppm of TBHQ. After 4 weeks (672 hours) at 180° C., the tensile properties were measured. Results are in Table 3.

### Example 15

Strips of spunbonded nonwoven web 2-2 were immersed in HOS oil containing 10 wt % epoxidized soybean oil acrylates as an additive. After 8 weeks (1344 hours) at 180° C., the tensile properties were measured. Results are shown in Table 3.

### Example 16

Strips of spunbonded nonwoven web 2-2 were immersed in HOS oil containing as additives 0.32 wt % TBHQ, 0.92 wt % Irganox 259, and 2 wt % epoxidized soybean oil acrylates. After 4 weeks (672 hours) at 180° C., the tensile properties were measured. Results are shown in Table 3.

### Example 17

Using strips of spunbonded nonwoven web 2-2, Example 17 was performed the same way as Example 16 but for 8 weeks (1344 hours). Tensile properties are shown in Table 3.

### Example 18

A sample of poly(meth)acrylate was prepared as follows for use as a pour point depressant. A mixture of stearyl methacrylate (51 g), isodecyl acrylate (31.8 g), butyl methacrylate (10.7 g), 2-ethylhexyl acrylate (29.7 g), lauryl methacrylate (54 g) and toluene (350 mL) was heated to 90° C. A solution of 1.0 g of Vazo® 64 in 30 mL toluene was added to the above reaction solution over 1 hour. The resulting mixture was stirred at 90° C. for another 16 hours. The reaction mixture was distilled under vacuum to removed solvent and unreacted monomers. The last period of distillation was carried out at 150° C. pot temperature and under 30 mmtorr vacuum for 1 hour to give a copolymer (175.8 g) as a remainder in the distillation pot. ¹H NMR analysis confirmed formation of the copolymer. Analysis by size exclusion chromatography indicated this copolymer has a molecular weight of about 55,600.

Strips of spunbonded nonwoven web 2-2 were immersed in HOS oil containing as additives 0.32 wt % TBHQ, 0.92 wt % Irganox 259, and 2 wt % of the poly(meth)acrylate pour point depressant (PPD). Copper chips (0.11 g) were also placed into the HOS oil. After 2 weeks (334 hours) at 180° C., the tensile properties were measured. Results are shown in Table 3.

### Example 19

Using strips of spunbonded nonwoven web 2-2, Example 20 was performed the same way as Example 18 but for 4 weeks (675 hours). Tensile properties are shown in Table 3.

### Example 20

Using strips of spunbonded nonwoven web 2-2, Example 20 was performed the same way as Example 18 but with the following differences. The HOS oil also contained 100 ppm of metal deactivator N,N′-bis(salicylidene)-1,2-propanediamine. After two weeks (334 hours) at 180° C., the tensile properties were measured. Results are shown in Table 3.

### Example 21

Using strips of spunbonded nonwoven web 2-2, Example 21 was performed the same way as Example 20 but for 4 weeks (675 hours). Tensile properties are shown in Table 3.

### Example 22

Strips of spunbonded nonwoven web 2-2 were immersed in HOS oil containing as additives 0.32 wt % TBHQ and 0.92 wt % Irganox 259. Copper chips (0.11 g) were also placed into the HOS oil. After 16 weeks (2684 hours) at 180° C., the tensile properties were measured. Results are shown in Table 3.

### Example 23

Strips of spunbonded nonwoven web 2-2 were immersed in HOS oil with no additives at 180° C. for 16 weeks (2684 hours). Tensile properties are shown in Table 3.

### Example 24

Using strips of spunbonded nonwoven web 2-2, Example 24 was performed the same way as Example 13 but using mineral oil instead of HOS oil. Results are shown in Table 3.

TABLE 3
Tensile Properties of Selected Comparative Examples (Papers)
and Examples 5 and 13-24 (Nonwoven Webs Comprising 25 wt % PTT in
the Sheath and 75 wt % PET in the Core).

| | | | | Tensile | | Tensile | | | | | |
|---|---|---|---|---|---|---|---|---|---|---|---|
| | | | | Strength | | Strength | | | | | |
| | | | | @ | | @ | | | | | |
| | | | Thick- | Rupture | Tensile | Rupture | Tensile | Elongation | | Elongation | Elongation |
| | | Age- | ness | (MD) | Strength | (XD) | Strength | @ Break | Elongation | @ Break | @ Break |
| | | ing | MD, | N/cm | Retention | N/cm | Retention | (MD) | @ Break | (XD) | Retention |
| | Liquid | Time | (XD) | (Std. | (MD) | (Std. | (XD) | % | Retention | % | (XD) |
| Example | Media | hr | μm | Dev.) | % | Dev.) | % | (Std. Dev.) | % | (Std. Dev.) | % |
| Comparative | None | n/a | 88 | 90.7 | n/a | 14.5 | n/a | 21.1 (+/− | n/a | 8.5 (+/− | n/a |
| Example A | | | | (+/−) 2.0) | | (+/−0.5) | | 0.6) | | 0.6) | |
| Comparative | HOS oil | 336 | 88 | 18.0 | 19.8 | 10.5 | 72.4 | 1.2 (+/− | 5.7 | 0.75 (+/− | 8.8 |
| Example G+ | | | | (+/−) 0.3) | | (+/−0.7) | | 0.1) | | 0.1) | |
| Comparative | Mineral oil | 336 | 83 | 10.2 (+/− | 11.2 | 4.3 (+/− | 29.7 | 0.6 (+/− | 2.8 | 0.4 (+/− | 4.7 |
| H+ | | | | 3.9) | | 1.3) | | 0.4) | | 0.1) | |
| Comparative | None | n/a | 88 | 94.2 | n/a | 17.0 | n/a | 27.3 (+/− | n/a | 8.7 (+/− | n/a |
| Example D | | | | (+/−2.7) | | (+/−0.4) | | 1.0) | | 0.9) | |
| Comparative | HOS oil | 336 | 83 | 15.8 | 16.8 | 12.3 | 72.4 | 0.7 (+/− | 2.6 | 0.8 (+/− | 9.2 |
| Example I# | | | | (+/−2.2) | | (+/−0.2) | | 0.3) | | 0.0) | |
| Comparative | Mineral oil | 336 | 83 | 8.4 (+/− | 8.9 | 3.1 (+/− | 18.2 | 0.4 (+/− | 1.5 | 0.4 (+/− | 4.6 |
| J# | | | | 4.1) | | 0.9) | | 0.4) | | 0.1) | |
| Example 5 | None | n/a | ~250 | 51.8 | n/a | 39.9 | n/a | 42.3 | n/a | 36.8 | n/a |
| | | | | (+/−2.7) | | (+/−1.0) | | (+/−4.7) | | (+/−4.6) | |
| Example 13 | HOS oil, | 336 | 250 | 45.9 | 88.6 | 41.8 | 104.8 | 17.1 (+/− | 40.4 | 22.3 (+/− | 60.6 |
| | no | | | (+/−1.1) | | (+/−2.5) | | 5.8) | | 5.1) | |
| | additives | | | | | | | | | | |
| Example 14 | HOS oil + | 672 | 298 | 54.3 | 104.8 | 45.0 | 112.8 | 27.7 (+/− | 65.5 | 25.1 | 68.2 |
| | 2000 ppm | | (317.5) | (+/−3.0) | | (+/−2.2) | | 2.8) | | (+/−1.8) | |
| | TBHQ | | | | | | | | | | |
| Example 15 | HOS oil + | 1344 | 288 | 48.1 | 92.9 | 38.0 | 95.2 | 23.7 | 56.0 | 24.0 | 65.2 |
| | 10 wt % | | (308) | (+/−2.2) | | (+/−1.5) | | (+/−5.4) | | (+/−10.8) | |
| | acrylated | | | | | | | | | | |
| | epoxidized | | | | | | | | | | |
| | soybean oil | | | | | | | | | | |
| Example 16 | HOS oil + | 672 | 250, | 43.9 | 84.7 | 37.6 | 94.2 | 10.1 (+/− | 23.9 | 18.0 (+/− | 48.9 |
| | 2 wt % | | (250) | (+/−1.1) | | (+/−4.1) | | 1.4) | | 3.6) | |
| | acrylated | | | | | | | | | | |
| | epoxidized | | | | | | | | | | |
| | soybean | | | | | | | | | | |
| | oil, | | | | | | | | | | |
| | 0.32% wt TBHQ | | | | | | | | | | |
| | and | | | | | | | | | | |
| | 0.92 wt % | | | | | | | | | | |
| | Irganox | | | | | | | | | | |
| | 259 | | | | | | | | | | |
| Example 17 | HOS oil + | 1344 | 250, | 37.7 | 72.8 | 39.4 | 98.7 | 8.2 (+/− | 19.4 | 14.9 (+/− | 40.5 |
| | 2% | | (250) | (+/−4.2) | | (+/−2.7) | | 4.8) | | 3.3) | |
| | acrylated | | | | | | | | | | |
| | epoxidized | | | | | | | | | | |
| | soybean | | | | | | | | | | |
| | oil, | | | | | | | | | | |
| | 0.32 wt % TBHQ | | | | | | | | | | |
| | and | | | | | | | | | | |
| | 0.92 wt % | | | | | | | | | | |
| | Irganox | | | | | | | | | | |
| | 259 | | | | | | | | | | |
| Example 18 | HOS oil | 334 | 250 | 47.8 | 92.3 | 37.1 | 93.0 | 15.8 (+/− | 37.4 | 20.4 (+/− | 55.4 |
| | 0.32 wt % TBHQ | | | (+/−4.2) | | (+/−0.8) | | 6.1) | | 3.2) | |
| | and | | | | | | | | | | |
| | 0.92 wt % | | | | | | | | | | |
| | Irganox | | | | | | | | | | |
| | 259.2 wt % | | | | | | | | | | |
| | PPD, Cu | | | | | | | | | | |
| | chips | | | | | | | | | | |
| Example 19 | HOS oil | 675 | 250 | 39.7 | 76.6 | 36.9 | 92.5 | 9.6 (+/− | 22.7 | 10.6 (+/− | 28.8 |
| | 0.32 wt % TBHQ | | | (+/−2.8) | | (+/−3.6) | | 1.0) | | 1.9) | |
| | and | | | | | | | | | | |
| | 0.92 wt % | | | | | | | | | | |
| | Irganox | | | | | | | | | | |
| | 259, | | | | | | | | | | |
| | 2 wt % PPD, | | | | | | | | | | |
| | Cu chips | | | | | | | | | | |
| Example 20 | HOS oil | 334 | 250 | 42.4 | 81.9 | 42.2 | 105.8 | 11.3 (+/− | 26.7 | 22.4 (+/− | 60.9 |
| | 0.32 wt % TBHQ | | | (+/−3.1) | | (+/−1.7) | | 2.7) | | 3.4) | |
| | and | | | | | | | | | | |
| | 0.92 wt % | | | | | | | | | | |
| | Irganox | | | | | | | | | | |
| | 259, | | | | | | | | | | |
| | 2 wt % PPD, | | | | | | | | | | |
| | 100 ppm | | | | | | | | | | |
| | metal | | | | | | | | | | |
| | deactivator, | | | | | | | | | | |
| | Cu chips | | | | | | | | | | |
| Example 21 | HOS oil | 675 | 250 | 40.6 | 78.4 | 34.0 | 85.2 | 11.4 (+/− | 27.0 | 9.9 (+/− | 26.9 |
| | 0.32 wt % TBHQ | | | (+/−2.4) | | (+/−1.7) | | 3.6) | | 2.6) | |
| | and | | | | | | | | | | |
| | 0.92 wt % | | | | | | | | | | |
| | Irganox | | | | | | | | | | |
| | 259, | | | | | | | | | | |
| | 2 wt % PPD, | | | | | | | | | | |
| | 100 ppm | | | | | | | | | | |
| | metal | | | | | | | | | | |
| | deactivator | | | | | | | | | | |
| | Cu chips | | | | | | | | | | |
| Example 22 | HOS oil | 2684 | 250 | 15.8 | 30.5 | 14.9 | 37.3 | 1.6 (+/− | 3.8 | 1.8(+/−0.1) | 4.9 |
| | 0.32 wt % TBHQ | | | (+/−0.3) | | (+/−1.3) | | 0.1) | | | |
| | and | | | | | | | | | | |
| | 0.92 wt % | | | | | | | | | | |
| | Irganox | | | | | | | | | | |
| | 259, Cu | | | | | | | | | | |
| | chips | | | | | | | | | | |
| Example 23 | HOS oil no | 2684 | 250 | 9.8 | 18.9 | 9.8 | 24.6 | 1.1 (+/− | 2.6 | 1.1(+/−0.2) | 3.0 |
| | additives | | | (+/−0.7) | | (+/−0.5) | | 0.3) | | | |
| Example 24 | Mineral oil | 336 | 250 | 1.9 (+/− | 4.0 | 3.9(+/− | 9.8 | 0.2 (+/− | 0.5 | 0.3 (+/− | 0.8 |
| | | | | 0.6) | | 1.4) | | 0.1) | | 0.1) | |

Note:
Percent retention values were calculated relative to the following samples:
+values for Comparative Examples G and H were calculated relative to Comparative Example A
^{#}values for Comparative Examples I and J were calculated relative to Comparative Example D
values for Examples 13 through 24 were calculated relative to Example 5

As the results in Table 3 show, the nonwoven webs retained very good tensile properties even after weeks of immersion in HOS oil at 180° C. Webs immersed for 4 weeks in HOS oil containing additives had very good and improved tensile strength retention in the machine direction, at least about 76% retention (Example 19) and higher, compared to that of Kraft paper (Comparative Example G, 19.8% retention) and thermally upgraded Kraft paper (Comparative Example 1, 16.8% retention) after two weeks of thermal aging in HOS oil at the same temperature. Nonwoven webs immersed for 8 weeks in HOS oil containing additives similarly showed very good tensile strength retention in the machine direction. Nonwoven webs immersed in additive-free HOS oil for 16 weeks retained about 19% tensile strength in the machine direction (Example 23), while nonwoven webs immersed in HOS oil containing antioxidants and copper chips retained about 30.5% tensile strength in the machine direction after the same period of time. This shows the positive effect of the additives on the mechanical stability of the nonwoven webs under the conditions tested. The nonwoven webs showed better stability in HOS oil than in mineral oil (Example 24).

### Comparative Example K

Commercially available thermally upgraded Kraft paper was used in an accelerated ageing study at 200° C. Strips of paper were immersed in vessels containing HOS oil for 2, 4, 7, 14, and 28 days; a different vessel was used for each time interval and each vessel contained five strips of paper. The tensile strength and elongation properties of the paper after ageing are reported in Table 4 as average values of the data for the five samples evaluated for each time interval. A control sample, which went through identical drying and paper immersion steps but which was not heated in the oven, was found to have an average water content of 79.0±7.3 ppm for the oil; tensile properties for the paper of the control sample are given in the Table as the room temperature data.

### Comparative Example L

Using commercially available thermally upgraded Kraft paper, Comparative Example L was performed the same way as Comparative Example K, except that the HOS oil contained as additives 0.32 wt % TBHQ and 0.92 wt % Irganox 259. The tensile strength and elongation results are shown in Table 4.

### Example 25

Example 25 was performed the same way as Comparative Example K except that strips of spunbonded nonwoven web 2-2 were used instead of thermally upgraded Kraft paper. The tensile strength and elongation properties of the aged web are shown in Table 4. A control vessel which went through identical drying and nonwoven web immersion steps, but which was not heated in the oven, was found to have an average water content of 99.1±5.5 ppm.

### Example 26

Using strips of spunbonded nonwoven web 2-2, Example 26 was performed the same way as Example 25, except that the HOS oil contained as additives 0.32 wt % TBHQ and 0.92 wt % Irganox 259. The tensile strength and elongation results are shown in Table 4.

TABLE 4
Tensile Properties of Comparative Examples K and L (Papers)
and Examples 25 and 26 (Nonwoven Webs Comprising 25 wt % PTT in the
Sheath and 75 wt % PET in the Core)

| | | | | | | | | Elongation @ |
|---|---|---|---|---|---|---|---|---|
| | | | | Thickness | Tensile Strength @ | Tensile Strength | Elongation @ | Max Load |
| | | Temperature | Time | μm (Std. | Max Load (MD) | Retention (MD) | Max Load (MD) | Retention (MD) |
| Examples | Media | ° C. | hr | Dev.) | N/cm (Std. Dev.) | % | % (Std. Dev.) | % |
| Comparative | HOS oil | Room | n/a | 76 | 45.3 (1.4) | n/a | 10.2 (1.0) | n/a |
| Example K | | temperature | | | | | | |
| | | 200 | 48 | 75 | 23.1 (0.6) | 51.0 | 1.4 (0.1) | 13.7 |
| | | 200 | 96 | 75 | 19.7 (1.5) | 43.5 | 1.1 (0.0) | 10.8 |
| | | 200 | 168 | 74 | 13.3 (5.9) | 29.4 | 0.8 (0.3) | 7.8 |
| | | 200 | 336 | 74 | 10.0 (5.1) | 22.1 | 0.6 (0.3) | 5.9 |
| | | 200 | 672 | 75 | 7.5 (0.2) | 16.6 | 0.7 (0.2) | 6.9 |
| Comparative | HOS oil | Room | n/a | 77 | 45.9 (1.3) | n/a | 8.4 (1.0) | n/a |
| Example L | 0.32 wt % TBHQ | temperature | | | | | | |
| | and 0.92 wt % | | | | | | | |
| | Irganox 259 | | | | | | | |
| | | 200 | 48 | 75 | 24.0 (1.3) | 52.3 | 1.4 (0.1) | 16.7 |
| | | 200 | 96 | 76 | 14.6 (6.9) | 31.8 | 0.8 (0.4) | 10.5 |
| | | 200 | 168 | 74 | 15.6 (2.0) | 34.0 | 0.9 (0.1) | 10.7 |
| | | 200 | 336 | 72 | 12.7 (0.9) | 27.7 | 0.7 (0.1) | 8.3 |
| | | 200 | 672 | 71 | 8.9 (2.6) | 19.4 | 0.4 (0.1) | 4.8 |
| Example 25 | HOS oil | Room | n/a | 246 (15) | 59.0 (2.6) | n/a | 59.6 (6.2) | n/a |
| | | temperature | | | | | | |
| | | 200 | 48 | 257 (13) | 56.3 (4.3) | 95.4 | 29.1 (5.4) | 48.8 |
| | | 200 | 96 | 264 (10) | 52.6 (7.0) | 89.2 | 19.8 (7.2) | 34.8 |
| | | 200 | 168 | 259 (10) | 54.1 (4.3) | 91.7 | 22.3 (3.7) | 37.4 |
| | | 200 | 336 | 262 (23) | 54.0 (5.2) | 91.5 | 18.8 (3.3) | 31.5 |
| | | 200 | 672 | 236 (15) | 50.4 (2.1) | 85.4 | 20.4 (6.6) | 34.2 |
| Example 26 | HOS oil | Room | n/a | 262 (15) | 58.0 (0.7) | n/a | 57.7 (3.0) | n/a |
| | 0.32 wt % TBHQ | temperature | | | | | | |
| | and 0.92 wt % | | | | | | | |
| | Irganox 259 | | | | | | | |
| | | 200 | 48 | 259 (8) | 51.3 (3.9) | 88.4 | 18.6 (2.2) | 32.2 |
| | | 200 | 96 | 251 (3) | 49.2 (5.7) | 84.8 | 17.0 (10.0) | 29.5 |
| | | 200 | 168 | 241 (15) | 47.1 (5.7) | 81.2 | 15.7 (5.3) | 27.2 |
| | | 200 | 336 | 249 (8) | 49.8 (6.2) | 85.9 | 16.6 (4.5) | 28.8 |
| | | 200 | 672 | 244 (15) | 35.3 (2.6) | 60.9 | 4.6 (0.6) | 8.0 |

Note:
For each Comparative Example or Example, percent retention values were calculated relative to the data for the oil-immersed room temperature sample.

As the results in Table 4 show, the nonwoven webs of Examples 25 and 26 showed sustained good mechanical properties such as tensile strength and elongation between 48 and 336 hours of ageing at 200° C., compared to the Kraft paper and thermally upgraded Kraft paper of Comparative Examples K and L, respectively, which showed sustained loss of mechanical properties under the same conditions.

### Example 27

Porosimetry, dielectric strength and tensile strength were measured for a spunbonded nonwoven web comprising 25 weight % PTT in the sheath and 75 weight % in the core and having no point-bonding (in contrast to the nonwoven webs used in the other Examples). Results are shown in Table 5.

The spunbonded nonwoven web was sandwiched between polyimide film (Kapton 300, DuPont, Wilmington Del.) and this inserted between 8″×8″ preheated 218° C. aluminum plates (203.2 mm×203.2 mm). This was placed between the 8″×8″ (203.2 mm×203.2 mm) faces of a Pasadena Hydraulic press, brought to 218° C. and 32,000 lbf (142 kN) and left for 5 minutes to press the nonwoven web. The plates were then removed and the pressed nonwoven retrieved. Porosimetry, dielectric strength and tensile strength were measured on the pressed nonwoven; results are shown in Table 5.

TABLE 5
Porosimetry, Dielectric Strength, and Tensile Strength Data for a
Nonwoven Web Comprising 25 wt % PTT in the Sheath and 75 wt % PET
in the Core Before and After Pressing.

| | | Tensile | | | | | | |
|---|---|---|---|---|---|---|---|---|
| | | Strength | Elongation | | | | | |
| | | @ max | @ max | Dielectric | | | | |
| | Thickness | load (MD) | load (MD) | strength | Skeletal | | Intrusion | Surface |
| | μm (Std. | N/cm | % | V/μm | density | Compressibility | volume | area |
| Examples | Dev.) | (Std. Dev.) | (Std. Dev.) | (Std. Dev.) | g cm⁻³ | ×10⁻¹⁰/Pa | cm³ g⁻¹ | m² g⁻¹ |
| before | 248 (6) | 9.90 (0.68) | 16.0 (0.6) | 29.4 (6.3) | 1.068 | −1.32 | 3.675 | 17.4 |
| pressing | | | | | | | | |
| after | 107 (13) | 57.8 (8.9) | 35.4 (7.6) | 34.1 (8.3) | 1.357 | −1.03 | 0.471 | 3.5 |
| pressing | | | | | | | | |

The increase in dielectric strength and decrease in intrusion volume obtained by pressing a nonwoven web comprising 25 weight % PTT in the sheath and 75 weight % in the core suggest that calendered nonwoven webs would have utility in higher voltage oil-filled electrical transformers. Intrusion volume and surface area are related to the porosity of the nonwoven web. A reduction in the porosity of the insulating material, for example by pressing or calendering, could allow for effective air displacement in an oil-filled transformer, which is necessary for adequate electrical performance.

### Example 28

Example 27 was repeated with the exception that the nonwoven web was calendered between rollers at 218° C. at a speed of 25 mm per minute at 40 psi using a 4 mil shin. Before calendering, the nonwoven web had thickness, tensile strength at maximum load (MD), and elongation at maximum load (MD) of 248 microns, 9.90 N/cm, and 16.0%, respectively. After calendering, the nonwoven web had thickness, tensile strength at maximum load (MD), and elongation at maximum load (MD) of 95 microns, 57.37 N/cm, and 38.51%, respectively.

The following materials were used in Example 29 through Example 36 and Comparative Examples M and N. All commercial reagents were used as received. The silica gel was dried in a vacuum oven at 200° C. for 3 days under about 200 torr vacuum before use.

Refined, bleached, and deodorized high oleic soybean oil (RBD HOS oil) containing triglycerides of the following fatty acids: palmitic acid

(6.5 wt %), stearic acid (4.15 wt %), oleic acid (73.9 wt %), linoleic acid (8.77 wt %), and linolenic acid (2.94 wt %) was obtained according to U.S. Pat. No. 5,981,781. Crude high oleic soybean oil (HOS oil) containing palmitic acid (6.5 wt %), stearic acid (4.1 wt %), oleic acid (74.8 wt %), linoleic acid (7.6 wt %), and linolenic acid (2.8 wt %) was obtained according to U.S. Pat. No. 5,981,781. Commodity Market Pantry™ brand name soybean oil containing triglycerides of the following fatty acids: palmitic acid (10.3 wt %), stearic acid (4.6 wt %), oleic acid (22.7 wt %), linoleic acid (53.5 wt %), and linolenic acid (7.2 wt %) was purchased from a Target store.

Methanol (99.8%), sodium carbonate (99.5%), potassium hydroxide (>85%), hexanes (99.9%), silica gel 60 and potassium carbonate (99.9%) were obtained from EMD Chemicals Inc. (Gibbstown, N.J.). Neopentyl glycol (99%), trimethylolpropane (97%), and pentaerythritol (98%) were obtained from Aldrich Company (Milwaukee, Wis.).

The following abbreviations are used: “GC” is gas chromatography, “C” is Celsius, “mm” is millimeter, “mL” is milliliter, “L” is liter, “min” is minute, “cm” is centimeter, “g” is gram(s), “mg” is milligrams, “h” is hour(s), “temp” or “T” is temperature, “Comp. Ex.” Is Comparative Example, “ID” is internal diameter, “NPG” is neopentyl glycol, “TMP” is trimethylolpropane, and “PE” is pentaerythritol. “ASTM” stands for American Society for Testing and Materials which provides standard protocols for material evaluation. “AOCS” stands for American Oil Chemists' Society which provides standard methods for material evaluation. “OECD” stands for Organization for Economic Co-operation and Development.

Methyl esters were analyzed using an Agilent 6890 Series GC with a Omegawax™ 320 column, 30 m long, diameter 320 μm, film thickness 0.30 μm. Oven ramp: Initial temp 160° C. holds for 5 minutes, then increase at 2° C./min to 220° C. and hold for 10 minutes, then increase at 20° C./min to 240° C. and hold for 5 minutes. The carrier gas was helium. Injection port 250° C., with pressure 11.55 psi; split ratio 50:1 split flow: 77.8 mL/min; total flow: 82.3 mL/min. Initial flow rate 1.6 ml/min with 11.56 psi. Flame ionization detector used set at 270° C., hydrogen flow 35 mL/min; air flow 400 mL/min; Mode constant column+makeup flow; combined flow 32.0, make up gas was helium. Reference standard GLC-461 (a mixture of 32 different methyl esters C4:0 to C24:1) from Nu-Chek Prep, INC. (Elysian, Minn.) was used to identify retention times of the methyl esters.

The properties of the polyol ester mixtures were evaluated according to the following test methods:

TABLE 6
Properties Measured and Test Methods Used

| Property | Test Method |
|---|---|
| Flash point | ASTM D-92 |
| Fire point | ASTM D-92 |
| Pour point | ASTM D-97 |
| Moisture in oil | ASTM D-1533 |
| Acid number | ASTM D-974 |
| Dielectric Breakdown Voltage | ASTM D-1816 |
| Power factor | ASTM D-924 |
| Resistivity | ASTM D-1169 |
| Viscosity | ASTM D-445 or obtained by using a |
| | TR 2000 rotational rheometer with |
| | a 28 mm DIN concentric cylinder |
| | geometry |
| Oil stability index | AOCS Cd 12b-92 (1997) |

### Example 29

### Preparation of a Mixture of Methyl Esters Comprising the Fatty Acid Moieties of RBD HOS Oil

A 2-L flask equipped with an overhead stirrer, condenser, and nitrogen blanket was charged with RBD HOS Oil (1007 g), methanol (249 g), and sodium carbonate (2 g). The reaction mixture was heated to reflux for 6.5 hours (final temperature was about 76° C.) while stirring at 360 rpm. After being cooled to room temperature, the reaction mixture was transferred into a separatory funnel and allowed to sit overnight at room temperature. The resulting bottom layer containing glycerol (170 g) was removed. The top layer was distilled under reduced pressure (1 torr) at 60° C. for 40 minutes to remove the remaining methanol (56.7 g). After removal of an additional glycerol layer (˜1 g) in a separatory funnel, the mixture of methyl esters (1006 g) was obtained as the remainder. GC analysis indicated it contained methyl palmitate (6.4 wt %), methyl stearate (4.0 wt %), methyl oleate (73.6 wt %), methyl linoleate (8.6 wt %), and methyl linolenate (2.7 wt %).

### Example 30

### Preparation of a Mixture of Methyl Esters Comprising the Fatty Acid Moieties of Crude HOS Oil

A 20-liter, jacketed, Pyrex® reactor equipped with mechanical stirring, reflux condenser, internal thermocouple, nitrogen inlet, and a drain was dried by sweeping with nitrogen overnight. The reactor was charged with crude HOS oil (12.0 kg), methanol (3.0 kg) and potassium carbonate (45 g). The mixture was heated to reflux under nitrogen for 3 hours. The reaction mixture was cooled to 25° C. The bottom layer containing glycerol (1.9 kg) was removed via the drain. The reactor, containing the top layer, was charged with methanol (400 g) and potassium carbonate (2.0 g). The mixture was heated to reflux for 2 hours. After being cooled to room temperature, the top layer of the reaction mixture was transferred to a 22-liter RB flask. The remaining methanol was distilled off at 50° C. under vacuum (200 to 5 torr) to give 11.48 kg of a mixture of crude methyl esters. GC analysis indicated that it contained methyl palmitate (6.5 wt %), methyl stearate (3.9 wt %), methyl oleate (76.1 wt %), methyl linoleate (7.0 wt %), and methyl linolenate (2.8 wt %).

### Example 31

### Preparation of a Mixture of NPG Esters from a Mixture of Methyl Esters Comprising the Fatty Acid Moieties of RBD HOS Oil

A mixture of the methyl esters comprising the fatty acid moieties of RBD HOS oil from Example 29 (917 g), KOH (2.0 g), and neopentyl glycol (139 g) was heated under 2 torr vacuum to 40-50° C. for 3 hours, then 50-100° C. for 1 hour, then 100-160° C. for 3 hours. During the heating period, the temperature gradually increased while the boiling slowed down. A total about 86.2 g of MeOH was recovered during the reaction in a liquid nitrogen trap. The reaction mixture was distilled under 30 m torr vacuum up to 210° C. to recover the unreacted methyl esters as distillate (95 g). The distillation residue was centrifuged and the resulting liquid was passed through a silica gel column [2″ (OD)×4″] to give a mixture of NPG esters as the product (732.6 g). The solid from the centrifuge was extracted with hexanes (2×150 mL). The silica gel column was washed with the combined hexane extracts and additional hexanes (300 mL). The combined hexane washes were concentrated and dried under vacuum to give an additional amount of the NPG esters as product (93.5 g). ¹H NMR analysis of the product confirmed its identify as a mixture of esters comprising neopentyl glycol and fatty acid moieties of RBD HOS oil. The composition was found to comprise 1% NPG monoesters, 97% NPG diesters, and 2% triglycerides (HOS oil).

### Example 32

### Preparation of a Mixture of NPG Esters from a Mixture of Methyl Esters Comprising the Fatty Acid Moieties of Crude HOS Oil

A mixture of the methyl esters comprising the fatty acid moieties of crude HOS oil from Example 30 (1196 g), KOH (2.38 g), and neopentyl glycol (178 g) was heated under 30-5 torr vacuum to 50-205° C. for 14 hours. The unreacted methyl esters (163 g) were recovered by reduced pressure distillation at about 15 mTorr. The distillation residue was centrifuged and the resulting liquid was passed through a silica gel column (22 g silica gel) to give a mixture of NPG esters as the product (910 g) after being dried at 110° C. under 20 m Torr vacuum for 1 hour. The solid from the centrifuge was extracted with hexanes (2×150 mL). The silica gel column was washed with the combined hexane extracts and additional hexanes (300 mL). The combined hexane washes were concentrated and dried under vacuum to give an additional amount of the NPG esters product (170 g). ¹H NMR analysis of the product confirmed its identify as a mixture of esters comprising neopentyl glycol and fatty acid moieties of crude HOS oil. The composition was found to comprise 2% NPG monoesters, 93% NPG diesters, and 5% triglycerides (HOS oil).

The suitability of using the product as a dielectric fluid was evaluated by measuring its electrical and physical properties using the methods listed in Table 6. Results are given in Table 7.

### Example 33

### Preparation of a Mixture of TMP Esters from a Mixture of Methyl Esters Comprising the Fatty Acid Moieties of RBD HOS Oil

A mixture of the methyl esters comprising the fatty acid moieties of RBD HOS oil from Example 29 (1094 g), KOH (2.2 g), and trimethylolpropane (140 g) was heated under 10 torr to 95° C. over 6 hours, then to 154° C. over an additional 4.5 hours. Additional KOH (0.47 g) was added and the mixture was heated under 0.8 torr at 123-150° C. for 8 hours more. During the heating period, the temperature gradually increased while the boiling slowed down. A total about 86.2 g of MeOH was recovered from the liquid nitrogen trap. The reaction mixture was distilled under 45 m torr vacuum up to 239° C. The unreacted methyl esters were collected as distillate (57.8 g). The distillation residue was centrifuged and the resulting liquid was passed through a silica gel column (˜14 g) to give a mixture of TMP esters as the product (970 g). The solid from the centrifuge was extracted with hexanes. The silica gel column was washed with the combined hexane extracts and additional hexanes (300 mL). The combined hexane washes were concentrated and dried under vacuum to give an additional amount of the mixture of TMP esters product (75 g).

A portion of the product obtained (847 g) was mixed with bleaching clay grade F-115FF (from BASF, 8.8 g), and Celite (2.2 g), and stirred at room temperature under vacuum (1 torr) for 1 hour, then heated to 110° C. for 1 hour under 0.5 torr. The mixture was cooled to room temperature and passed through a ½″ silica gel column (ID 1.5″). The collected product was heated to 110° C. for 1 hour under 0.1 torr before it was evaluated. ¹H NMR analysis of the product confirmed its identify as a mixture of esters comprising trimethylolpropane and fatty acid moieties of RBD HOS oil. The composition was found to comprise 2% TMP diesters, 90% TMP triesters, and 8% triglycerides (HOS oil).

The suitability of using the product as a dielectric fluid was evaluated by measuring its electrical and physical properties using the methods listed in Table 6. Results are given in Table 7.

### Example 34

### Preparation of a Mixture of TMP Esters from a Mixture of Methyl Esters Comprising the Fatty Acid Moieties of Crude HOS Oil

A mixture of the methyl esters comprising the fatty acid moieties of crude HOS oil from Example 30 (1213 g), KOH (2.4 g), and trimethylolpropane (156 g) was heated under 10 torr to 103° C. over 2 hours. Then the pressure was reduced to 15 torr and the reaction mixture was heated to 193° C. over 7.5 hour. The reaction mixture was then distilled under 40 mTorr vacuum to recover the unreacted methyl esters as distillate. The distillation residue was centrifuged and the resulting liquid was passed through a silica gel column (18 g silica gel) to give an oil which was further dried under 30 mTorr at 110° C. for 1 hour to give a mixture of TMP esters as the product (962 g). The solid from the centrifuge was extracted with hexanes. The silica gel column was washed with the combined hexane extracts and additional hexanes. The combined hexane washes were concentrated and dried to give an additional amount of product (108 g). ¹H NMR analysis of the product confirmed its identify as a mixture of esters comprising trimethylolpropane and fatty acid moieties of crude HOS oil. The composition was found to comprise 1.4% TMP diesters, 97.4% TMP triesters, and 1.2% triglycerides (HOS oil).

The suitability of using the product as a dielectric fluid was evaluated by measuring its electrical and physical properties using the methods listed in Table 6. Results are given in Table 7.

For biodegradability testing, another sample of the mixture of TMP esters was prepared from a mixture of methyl esters comprising the fatty acid moieties of crude HOS oil. The sample was prepared similarly to the TMP ester mixture of Example 6, and its composition was found by ¹H NMR analysis to comprise 90.2% TMP triesters, 2% TMP diesters, and 7.8% triglycerides (HOS oil).

Ready biodegradability of the TMP ester mixture was evaluated using the 28-day CO₂ Evolution Test for “Ready Biodegradation” according to the OECD Guideline 301B in the version dated Jul. 17, 1992. The biological system used was secondary activated sludge from the Elkton, Md. (USA) Publicly-Owned Treatment Works. The TMP ester mixture was found to meet the criteria for “Ready Biodegradation” under the conditions of the test. The test material reached a maximum biodegradability of 74%. Greater than 60% biodegradability was reached within 10 days of exceeding 10% biodegradation.

### Example 35

### Preparation of a Mixture of PE Esters from a Mixture of Methyl Esters Comprising the Fatty Acid Moieties of RBD HOS Oil

A mixture of the methyl esters comprising the fatty acid moieties of RBD HOS oil from Example 29 (100.6 g), KOH (0.2 g), and pentaerythritol (9.8 g) was heated under 5 torr to 80° C. over 1.5 hours and held at 80° C. for 1.5 hours, then heated to 160° C. over 4.5 hours. The reaction mixture was then distilled under 18 m torr vacuum to recover the unreacted methyl esters as distillate. The distillation residue was centrifuged and the resulting liquid was passed through a short silica gel column to give a mixture of PE esters as the product (60.4 g). The solid from the centrifuge was extracted with hexanes. The silica gel column was washed with the combined hexane extracts and additional hexanes. The combined hexane washes were concentrated and dried to give an additional amount of the mixture of PE esters product (21.6 g). ¹H NMR analysis of the product confirmed its identify as a mixture of esters comprising pentaerythritol and fatty acid moieties of RBD HOS oil. The composition was found to comprise 1.5% PE triesters, 94% PE tetraesters, and 4.5% triglycerides (HOS oil).

### Example 36

### Preparation of a Mixture of PE Esters from a Mixture of Methyl Esters Comprising the Fatty Acid Moieties of Crude HOS Oil

A mixture of the methyl esters comprising the fatty acid moieties of crude HOS oil from Example 30 (1190 g), KOH (2.41 g), and pentaerythritol (116 g) was heated under 1-100 torr at 80-205° C. for 65 hours. More KOH (1.3 g) was added and the reaction mixture was further heated under 5 torr at 200-220° C. for 34 hours. The excess methyl esters were removed by distillation under 1 torr vacuum at 235-330° C. pot temperature. The distillation residue was centrifuged and the resulting liquid was passed through a silica gel column (14 g), then dried at 110° C. under 0.1 torr vacuum for 1 hour to give a mixture of PE esters as the product (930 g). ¹H NMR analysis of the product confirmed its identify as a mixture of esters comprising pentaerythritol and fatty acid moieties of crude HOS oil. The composition was found to comprise 4% PE triesters, 90% PE tetraesters, and 6% triglycerides (HOS oil).

The suitability of using the product as a dielectric fluid was evaluated by measuring its electrical and physical properties using the methods listed in Table 6. Results are given in Table 7.

### Comparative Example M

### Preparation of a Mixture of Methyl Esters Comprising the Fatty Acid Moieties of Commodity Soybean Oil

A 2-L flask equipped with an overhead stirrer, condenser, and nitrogen blanket was charged with Market Pantry™ brand name soybean oil (1009 g), methanol (250 g), and potassium carbonate (3.1 g). The reaction mixture was heated to reflux for 3.5 hours. The resulting bottom layer containing glycerol was removed, and more methanol (50 g) and potassium carbonate (0.2 g) were added. The reaction mixture was refluxed for another 3.5 hours. After the reaction mixture was cooled to room temperature, the excess methanol was removed by vacuum distillation at 25° C. for 1 hour. The product layer was filtered through a thin layer of silica to give a mixture of methyl esters comprising the fatty acid moieties of commodity soybean oil (968 g).

### Comparative Example N

### Preparation of a Mixture of TMP Esters from a Mixture of Methyl Esters Comprising the Fatty Acid Moieties of Commodity Soybean Oil

A mixture of the methyl esters comprising the fatty acid moieties of commodity soybean oil from Comparative Example M (968 g), trimethylolpropane (97.9 g), and sodium methoxide (1.8 g) was heated to 68° C. in 1 hour under 5-Torr vacuum. The reaction temperature was then slowly increased to 185° C. over 6 hours. The excess methyl esters were removed by distillation under vacuum (˜20-m torr) at 225° C. pot temperature. The distillation residue was centrifuged and the resulting liquid was passed through a silica gel column (14 g) then dried at 110° C. under 0.1 Torr vacuum for 1 hour to give a mixture of TMP esters as the product (597 g). ¹H NMR analysis of the product confirmed its identity as a mixture of esters comprising trimethylolpropane and fatty acid moieties of commodity soybean oil.

The suitability of using the product as a dielectric fluid was evaluated by measuring its electrical and physical properties using the methods listed in Table 6. Results are given in Table 7.

The polyol ester mixtures obtained in Example 32, Example 33, Example 34, Example 36, and Comparative Example N were evaluated using the methods listed in Table 6. Samples of Envirotemp® FR3™ fluid (Cooper Industries, Inc.), which is a vegetable oil-based fluid formulated from commodity soybean oil, and Midel® 7131 (The Micanite and Insulators Co., Manchester UK), which is a synthetic ester composition of linear and branched C₅ to C₁₀ fatty acids as mixed esters with pentaerythritol, were also evaluated using the same methods. The data are presented in Table 7.

TABLE 7
Summary of Dielectric Fluid Properties Measured

| | Envirotemp ® | Midel ® | Example | Example | Example | Example | |
|---|---|---|---|---|---|---|---|
| Properties Measured | FR3 ™ | 7131 | 32 | 33 | 34 | 36 | Comp. Ex. N |
| Flash point (° c.) | 328 | 263 | 288 | 318 | 324 | 338 | 320 |
| Fire point (° c.) | 352 | 306 | 330 | 374 | 378 | 378 | 382 |
| Pour point (° c.) | −20 | −50 | −14 | −38 | −38 | −14 | −41 |
| H₂O (ppm) | 281 | 77 | 43 | 25 | 23 | 19 | 18 |
| Power Factor (%) 25° C. | 0.164 | 0.023 | 0.132 | 0.022 | 0.023 | 0.149 | 2.02 |
| Power Factor (%) 100° C. | 3.01 | 0.75 | 4.8 | 0.9 | 0.81 | 2.98 | 19.6 |
| Dielectric Breakdown | 30 | 43 | 36 | 45 | 39 | 48 | not |
| Voltage (KV) | | | | | | | measured |
| (1 mm gap @25° C.) | | | | | | | |
| Resistivity (E12 ohm-cm) | 5.65 | 0.231 | 10.9 | 6.02 | 4.64 | 12.4 | 1.59 |
| Acid Number (mg KOH/g) | 0.037 | 0.03 | 0.165 | 0.015 | 0.007 | 0.516 | 0.022 |
| Viscosity (cST) 40° C. | 34 | 28* | 24 | 41.8* | 41.8* | 23.6 | 36 |
| Viscosity (cST) 100° C. | 8 | 5* | 6 | 9* | ‘9* | 13.6 | 8.4 |
| OSI (hours at 110° C.) | 9.7 | >100 | 28.2 | 14 | 8.5 | 26 | 1.4 |

*Measured by a TR 2000 rotational rheometer

The data in Table 7 show that the mixtures of polyol esters of the Examples have desirable properties for use as dielectric fluids. The flash points and fire points of the fluids of the Examples are suitably high, and significantly higher than those of the synthetic ester composition Midel® 7131. They also have significantly lower moisture content than Midel® 7131 and the vegetable oil-based Envirotemp® FR3™. In comparison to the polyol esters of Comparative Example N (derived from the reaction of trimethylolpropane and the mixture of methyl esters of fatty acid moieties derived from commodity soybean oil), the analogous polyol esters of Example 33 (derived from the reaction of trimethylolpropane and the mixture of methyl esters of fatty acid moieties derived from high oleic soybean oil) show better electrical properties in terms of the power factor, both when measured at 25° C. and when measured at 100° C. The extremely high power factors of the fluid of Comparative Example N would preclude its use as a dielectric fluid. In contrast, the characteristics of the fluid of Example 33 show that it is suitable for use as a dielectric fluid. In terms of OSI values, which reflect oxidative stability, as both Envirotemp® FR3™ and Midel® 7131 fluids contain added antioxidants the more meaningful comparison is between the dielectric fluids of Examples 32 though 36 and Comparative Example N as these materials did not contain added antioxidants. The fluids of Examples 32 through 36 demonstrated significantly longer induction periods than did that of Comparative Example N, reflecting the greater oxidative stability provided by the higher content of unsaturated moieties.

What is claimed is:

1. An insulating material comprising:
a nonwoven web comprising a plurality of continuous spunbonded polyester bicomponent fibers, wherein each of the plurality of bicomponent fibers comprises:
a) from about 20% by weight to about 80% by weight of poly(ethylene terephthalate) in a core; and
b) from about 80% by weight to about 20% by weight of poly(trimethylene terephathalate) in a sheath surrounding the core,
wherein the amounts in % by weight are based on the total weight of each of the plurality of bicomponent fibers.

2. The insulating material of claim 1, wherein the nonwoven web has a tensile strength retention at rupture in the machine direction of at least about 70% after about 4 weeks of immersion in vegetable oil at about 160° C.

3. The insulating material of claim 1, wherein the nonwoven web has an elongation retention in the machine direction of at least about 55% after about 4 weeks of immersion in vegetable oil at about 160° C.

4. The insulating material of claim 1, wherein the nonwoven web has a basis weight in the range of about 25 gsm to about 500 gsm.

5. The insulating material of claim 1, wherein the nonwoven web is pressed or calendered.

6. The insulating material of claim 1, wherein each of the plurality of bicomponent fibers comprises:
a) from about 25% by weight to about 50% by weight of poly(ethylene terephthalate) in the core; and
b) from about 75% by weight to about 50% by weight of poly(trimethylene terephthalate) in the sheath surrounding the core.

7. The insulating material of claim 1, wherein each of the plurality of bicomponent fibers comprises:
a) 75% by weight of poly(ethylene terephthalate) in the core; and
b) 25% by weight of poly(trimethylene terephthalate) in the sheath surrounding the core.

8. The insulating material of claim 1, wherein each of the plurality of bicomponent fibers comprises:
a) 50% by weight of poly(ethylene terephthalate) in the core; and
b) 50% by weight of poly(trimethylene terephthalate) in the sheath surrounding the core.

9. The insulating material of claim 1, further comprising Kraft paper and/or thermally upgraded Kraft paper.

10. A dielectric material comprising a nonwoven web impregnated with at least 10 wt % of a dielectric fluid, wherein the nonwoven web comprises a plurality of continuous spunbonded polyester bicomponent fibers, wherein each of the plurality of bicomponent fibers comprises:
a) from about 20% by weight to about 80% by weight of poly(ethylene terephthalate) in a core; and
b) from about 80% by weight to about 20% by weight of poly(trimethylene terephathalate) in a sheath surrounding the core,
wherein the amounts in % by weight are based on the total weight of each of the plurality of bicomponent fibers.

11. The dielectric material of claim 10, wherein the nonwoven web has a tensile strength retention at rupture in the machine direction of at least about 70% after about 4 weeks of immersion in vegetable oil at about 160° C.

12. The dielectric material of claim 10, wherein the nonwoven web has an elongation retention in the machine direction of at least about 55% after about 4 weeks of immersion in vegetable oil at about 160° C.

13. The dielectric material of claim 10, wherein the dielectric fluid comprises a triglyceride oil, a mixture comprising polyol esters, or combinations thereof; wherein
the triglyceride oil comprises a vegetable oil, a vegetable oil based fluid, an algal oil, or mixtures thereof; and
the mixture comprising polyol esters is derived from reaction of:
a) a polyol comprising pentaerythritol, trimethylolpropane, neopentyl glycol, or combinations thereof; and
b) a mixture of fatty acid esters derived from a high oleic soybean oil comprising fatty acid moieties; wherein the high oleic soybean oil has
i) a C18:1 content of greater than 65% of the fatty acid moieties in the oil; and
ii) a combined C18:2 and C18:3 content of less than 20% of the fatty acid moieties in the oil.

14. An electrical apparatus comprising:
a dielectric fluid and an insulating material;
wherein the insulating material comprises a nonwoven web comprising a plurality of continuous spunbonded polyester bicomponent fibers, and
wherein each of the plurality of bicomponent fibers comprises:
a) from about 20% by weight to about 80% by weight of poly(ethylene terephthalate) in a core; and
b) from about 80% by weight to about 20% by weight of poly(trimethylene terephathalate) in a sheath surrounding the core,
wherein the amounts in % by weight are based on the total weight of each of the plurality of bicomponent fibers.

15. The electrical apparatus of claim 14, wherein the dielectric fluid comprises a triglyceride oil, a mixture comprising polyol esters, or combinations thereof; wherein
the triglyceride oil comprises a vegetable oil, a vegetable oil based fluid, an algal oil, or mixtures thereof; and
the mixture comprising polyol esters is derived from reaction of:
a) a polyol comprising pentaerythritol, trimethylolpropane, neopentyl glycol, or combinations thereof; and
b) a mixture of fatty acid esters derived from a high oleic soybean oil comprising fatty acid moieties; wherein the high oleic soybean oil has
i) a C18:1 content of greater than 65% of the fatty acid moieties in the oil; and
ii) a combined C18:2 and C18:3 content of less than 20% of the fatty acid moieties in the oil.
